(19) United States
(12) Patent Application Publication
(10) Pub. No.: US 2010/0026789 A1
(43) Pub. Date: Feb. 4, 2010

(54) Moveable console for holding an image acquisition or medical device, in particular for the purpose of brain surgical interventions, a method for 3d scanning, in particular, of parts of the human body, and for the electronic recording and reconstruction of information regarding the scanned object surface

(76) Inventor: Attila Balogh, Budapest (HU)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 11/662,972

(22) PCT Filed: Sep. 16, 2005
(86) PCT No.: PCT/IB05/53046

§ 371 Date: Jun. 2, 2009

(30) Foreign Application Priority Data
Sep. 20, 2004 (HU) P0401874

(51) Int. Cl. H04N 13/02; H04N 7/18

(52) U.S. Cl. 348/50; 348/77; 348/E07.085; 348/E13.074

(57) ABSTRACT

A moveable console for holding an image acquisition or medical device, in particular for the purpose of brain surgical interventions. A method for the 3D scanning of, in particular, approached parts of the human body, and the electronic recording and reconstruction of information regarding the scanned object surface.

### TECHNICAL FIELD

The subject matter of the present invention is, on the one hand, a moveable console for holding an image acquisition or medical device, in particular for the purpose of brain surgical interventions, comprising a holder fixing the device immovably; said holder being comprised in a supporting arm, whereas the supporting arm is designed as a single- or multi-member supporting arm; furthermore, the supporting arm is connected to the operative table in a revolving and hinged manner; the supporting arm is associated with at least one moving means moving it relative to the operative table; the supporting arm and/or the moving means is associated with position or movement sensors; and at least one moving means and the position or movement sensors are connected to a control unit. The subject matter of the present invention is, on the other hand, a method for the 3D scanning of, in particular, approached parts of the human body, and the electronic recording and reconstruction of information regarding the scanned object surface, in the course of which image recordings are made of the object surface in pre-defined area-units and along a pre-defined trajectory; individual image recordings are stored retrievably in a database, so that each image is also assigned a sequence datum referring to the sequence of recording; in the course of reconstruction, individual image recordings are displayed after retrieval based on the sequence data; and image acquisition takes place in the course of the approach of the object surface, on one continuous object surface layer after the other, consecutively.

More generally speaking, the subject matter of the present invention is a portable, robot-controlling, image-processing, image-reconstruction, image-display equipment which can be mounted on an operative table and applicable for spatial targeting of stereotactic devices and/or the spatial positioning and control of image acquisition devices, and a relevant method. Said equipment and method are suitable for the 4D recording, storage, reconstruction and display of multimedia-based interactive (stereoscopic) image content of anatomic dissections and surgical approaches, the storage, resetting, and reproduction of the parameters required for image acquisition, the reading/interpretation of a volumetric data set, e.g. a file in DICOM format, and the targeting of the holder of the console structure on the basis thereof. The reconstructed image content can be transmitted to a databank, e.g. written on hard disk, distributed for training or archiving purposes, studied with the help of image display software applications running on easily accessible general IT platforms.

### BACKGROUND ART

Simple, compact and not very expensive video systems suitable for the purpose of observing stereotactic surgical approaches or anatomic dissections are manufactured and distributed, among others, by Stoelting Co., Wood Dale, Ill., US. This system co-operates with a computer, and an expansion card to be put in the computer incorporates the software for recording images or video series. Furthermore, the system also includes an image-handling software and a program to maintain the database of the recorded images and files, and consists, basically, of a console associated with an operative table or a stage, a holder secured to the end of the console and, furthermore, a portable display and a CCD camera that can be fitted into the holder. The solution typically includes a gooseneck-shaped console, fixed in a heavy base acting as counterweight, and in the course of the application of the system, the camera put into the holder is positioned above the surface to be recorded or, in other words, scanned, with the help of this supporting arm that can be moved and set with freedom in every direction. The deficiency of this solution is that, in order to record a larger area, the objective/lens system of the camera must be modified, or the camera must be repositioned by repeated manual positioning of the supporting arm, and it may be considered a further deficiency that the person carrying out the dissection or operation will be encumbered by the already positioned camera which, however, cannot be repositioned exactly once removed, even if only temporarily.

Several equipments and methods have been developed for the purpose of the robotic-type control of image acquisition or medical devices, to record images or carry out interventions, respectively, as the case may be, in the area designated in the description of the subject matter of the present invention. These include the robotic arm called NeuroMate® and the Robodoc System® of Integrated Surgical Systems, Inc. developed to facilitate stereotactic brain surgeries. To my best knowledge, perhaps the most successful, commercially available, robotic device is the Automated Endoscopic System for Optimal Positioning® (AESOP), a robotic laparoscopic camera holder designed and manufactured by Computer Motion Inc., and used effectively to the present day in numerous clinical areas. The common feature of these systems is that they all comprise a console allowing a high degree of freedom of motion and positioning, with the optical or medical device being placed at the tip of the said structure, and the latter's position and movement being controlled, usually remote-controlled, occasionally by voice control, in a way allowing to set the time parameter, too, with the help of a computerized control unit or system. The area of application of the said systems demands that any positioning/movement be executable with a very high degree of precision, while another, so far not sufficiently satisfied demand, is that the equipment be transportable from one place of application to another without major hindrances.

The equipment called NeuroMate® mentioned already is an image-guided, computer-controlled robotic system for stereotactic functional brain surgeries. The equipment includes a pre-surgical planning workstation. The system positions, orients and manipulates the operating tools within the surgical field exactly as planned by the surgeon performing the operation on the pre-surgical image planning workstation. The system interacts with the surgeon during surgery, and adapts easily to changes/new situations required by surgery. The advantage of this solution is that it allows to do without the previously absolutely necessary traditional head frames used to the present day in manual techniques of brain surgeries, and allows to assign previously acquired data to the actual position of the subject matter of the intervention.

Other equipment and methods of image-guided surgical intervention are described among others by Grimson, Ettinger, Kapur, Leventon, Wells and Kikinis: ‘Utilizing Segmented MRI Data in Image-Guided Surgery’, published in IJPRAI in 1996, and in Grimson, Lorenzo-Perez, Wells, Ettinger, White and Kikinis: ‘An Automatic Registration Method for Frameless Stereotaxy, Image-guided Surgery and Enhanced Reality Visualisation’, published in Transactions on Medical Imaging in 1996. The common feature of these solutions is that they are image-directed neuro-navigation systems, designed to ensure, among others, that surgical approaches be executed at the most precise location, in the safest and simplest way. Hardin's article entitled ‘Image fusion aids brain surgeons’ published in January 2000 in E-Reports (Technology and Trends for the Optical Engineering Community), No. 193, describes in detail how bringing volumetric data or magneto-resonance data into registration with the head of the patient to be operated on allows to avoid the use of the painful head frame in brain surgeries. In this solution, first the operational area is laser-scanned. On the basis of the captured image, the operator of the equipment uses the mouse to select the region of interest and to erase all laser points outside that area. 3D coordinates are then determined for the laser points in the target area, and then a two-step algorithm brings the 3D model data developed by the MRI into registration with the video feed. The equipment indicates optically less-than-1-mm registration between the MRI and video in real-world coordinates. Once the MRI model and the video stream are registered in real-world 3D coordinates, any part of the MRI model, including the skin, can be displayed on the video overlay, too, with the indicated precision.

Beside the solutions outlined above, ‘Intraoperative Stereoscopic QuickTime Virtual Reality’ by Balogh et al., J. Neurosurg, Vol. 100, pp. 591-596, April 2004, describes a system applicable primarily in brain surgical interventions and anatomical dissections in order to capture detailed, 3D images of the operational area affected by the intervention. In this known solution, a Zeiss® equipment used in stereotactic surgeries is provided with an optical image acquisition device of some sort, most often a CMOS or CCD camera, and the operational area is scanned relative to a specific grid system, and the scanned images are stored in a database, with file names including parameters referring to the image-acquisition circumstances being used for the purpose of retrieval in general. In order to obtain error-free images in each time plane, that is, in each layer, great caution is needed to prevent any damage to the sequence and matching of the photographic images and their respective file names. Only this will ensure that we obtain, in the course of image reconstruction/navigation, the image matching the selected or searched place, as the we can move between the often very high number of very large files sequentially only. This often results in an excessive increase of the time required for retrieving the image associated with the selected point. Another drawback of this known solution is that, due to the properties of the device itself, the positioning of this almost built-in Zeiss equipment takes a very long time, and hence it is not suited for the real-time recording of surgical interventions, but only, rather, for the documentation of anatomic dissections.

### DISCLOSURE OF INVENTION

### Technical Problem

The stereotactic operating, stereo robotic microscope (MKM STN system, hereinafter: microscope) used in our days was developed for executing stereotactic surgical approaches, not for the purpose of image acquisition and reconstruction and, accordingly, the relevant hardware and software design has many features that are disadvantageous from the point of view of our present objective. We have so far exploited those advantages of the robotics of the microscope for the purpose of image reconstruction which make it possible to move the microscope optics around a point, selected within the focal length, along a spherical surface segment, according to a pre-defined pattern (i.e., a pre-defined sequence of spatial positions). The currently accessible solution comprises a dedicated software, the modified (Zeiss-based) MKM software, the MKM-STN system and two digital cameras mounted on it. The microscope itself is positioned step by step, manually, which makes the process of image acquisition highly time-consuming and hence the entire image reconstruction technology inadequate for the purpose of recording/documenting surgical procedures. Given the fact that the image acquisition time demand of a single image grid, i.e. ‘layer’, is currently minimum 30 but often 45 minutes, depending on the number of images, the repetition of this procedures 10 to 15 and occasionally even more times during a single surgical procedure is not feasible, as it would boost the duration of the operation, the burden to the patient and hence the risk of the operation to an unacceptable degree.

It is a further problem that even simulated surgery on cadaver heads must be performed in one session once the head is immobilized, as any movement thereof would make it practically impossible to reproduce the orientation and position of the grid with millimeter precision and that would result in the non-alignment of the images. Such shifts are almost always so significant that they cannot be corrected by the software (e.g. by cutting the edges of the pictures, which would decrease the information content of the montage anyway.) Hence the entire simulated surgical procedure on the cadaver must be performed in one session, which further restricts the possibility to record all the phases of interest of the operation, and both the size of the spatial grid and the number of pictures and layers, respectively, must be limited. Recording 10-20 layers of a grid consisting of 150 pictures requires around 30-40 hours of uninterrupted operator work in case of simulation surgery of this type.

The console and the preferably computerized control unit proposed by the present invention will be of a size allowing (hand) portability. The equipment is light, it can be realized with relatively cheap technology and be mounted on the operating table, as opposed to the known stereotactic operating robotic microscope which is an armed robot weighing almost one ton and hence very difficult to move. The latter's movement requires special transport devices and moving means (electric motors). The accessibility of this microscope is limited not only by its weight, but also by its size (approximately 2×1, 5×1 m, i.e. 7×5×3 ft). In addition to the size and weight of the microscope, the most significant hindrance to the extensive use for the purpose of image acquisition and reconstruction, as detailed above, of this operational microscope, designed for another application anyway, is the very high counter-value of the technology incorporated in the structure. It should be mentioned in this context that the commercial off-the-shelf software of the microscope must be reprogrammed in each case for the purpose of image acquisition. It is only this modified software that will allow us to establish a spatial grid around a single point, and to move the microscope manually from one point to another while making pictures in the course of the process for the purpose of subsequent image reconstruction. Hence in the case of the known robotic microscope, this practically inaccessible, modified software is indispensable for using the current technology.

The fact that the total image acquisition process is regulated manually considerably reduces the speed of this methodology. Consequently, in its present state, it is not applicable for the documentation of surgical processes, image acquisition in different surgical stages and surgical image reconstruction—it can only be used for image acquisition in simulated surgeries, on cadavers, in laboratory circumstances. However, given the hardware constraints cited above, the application of this technology is a difficult and cumbersome, often tiring and lengthy procedure even under laboratory circumstances. Another drawback of the currently available technology is that the number of images recorded in one grid, in one layer, depends on time and human performance. Hence recording a sufficient number of pictures in a grid (200×10-15 s=˜50 min) to ensure smooth image transition while browsing in the final reconstruction requires tedious work. The more pictures are taken within one grid, the finer, the smoother the experience provided by movement in the final image reconstruction montage, given the smaller shifts in between the images. However, the more pictures are taken in one grid, the longer the image acquisition time, as the movement of the robotic microscope from one position to the next is manually controlled in each case. With the current system, image acquisition and the manual repositioning of the robotic microscope takes around 10-15 seconds, hence we are often forced to limit the size of the spatial grid or the number of images which, in turn, inevitably confines the ‘optical field’ of the final reconstruction and makes movement in the final image montage unpleasantly bumpy, ‘not continuous’, ‘not fine’. Manual camera control is yet another source of errors deteriorating the quality of the final image reconstruction montage. (It may happen that, in a given position, one only of the two cameras is shot, and hence in that position one member only of the stereoscopic image-pair will be available. Consequently, only a mono image is produced in that position, and it is impossible to generate its pair. Hence in this position one is obliged to ‘cheat’ and bring in the adjacent image-pair, that is, repeat images in the given grid position, which deteriorates the overall quality of the image montage. A further disadvantage in such cases is that when, in the case of multi-layer mapping, the appropriate pair of images is made precisely at the same point of the next layer, a misalignment will occur between the ‘spoiled’ and the ‘correct’ layers in the same spatial position. Owing to the rather basic software of the microscope, as of now, it is not possible to return to the same position after having ‘spoiled’ something, and to repeat the image acquisition process in that position. Hence we either accept that the image was spoiled and replace it as indicated above with an adjacent pair, or we start image acquisition anew, meaning the repetition of 40-50 minutes of work. The longer we work, often 30 to 40 hours, the more frequent this type of error will become as attention wavers and fatigue sets in.

### Technical Solution

The console and the preferably computerized control unit proposed by the present invention will be of a size allowing (hand) portability. The equipment is light, it can be realized with relatively cheap technology and be mounted on the operating table, as opposed to the known stereotactic operating robotic microscope which is an armed robot weighing almost one ton and hence very difficult to move. The latter's movement requires special transport devices and moving means (electric motors). The accessibility of this microscope is limited not only by its weight, but also by its size (approximately 2×1, 5×1 m, i.e. 7×5×3 ft). In addition to the size and weight of the microscope, the most significant hindrance to the extensive use for the purpose of image acquisition and reconstruction, as detailed above, of this operational microscope, designed for another application anyway, is the very high counter-value of the technology incorporated in the structure. It should be mentioned in this context that the commercial off-the-shelf software of the microscope must be re-programmed in each case for the purpose of image acquisition. It is only this modified software that will allow us to establish a spatial grid around a single point, and to move the microscope manually from one point to another while making pictures in the course of the process for the purpose of subsequent image reconstruction. Hence in the case of the known robotic microscope, this practically inaccessible, modified software is indispensable for using the current technology.

The fact that the total image acquisition process is regulated manually considerably reduces the speed of this methodology. Consequently, in its present state, it is not applicable for the documentation of surgical processes, image acquisition in different surgical stages and surgical image reconstruction—it can only be used for image acquisition in simulated surgeries, on cadavers, in laboratory circumstances. However, given the hardware constraints cited above, the application of this technology is a difficult and cumbersome, often tiring and lengthy procedure even under laboratory circumstances. Another drawback of the currently available technology is that the number of images recorded in one grid, in one layer, depends on time and human performance. Hence recording a sufficient number of pictures in a grid (200×10-15 s=˜50 min) to ensure smooth image transition while browsing in the final reconstruction requires tedious work. The more pictures are taken within one grid, the finer, the smoother the experience provided by movement in the final image reconstruction montage, given the smaller shifts in between the images. However, the more pictures are taken in one grid, the longer the image acquisition time, as the movement of the robotic microscope from one position to the next is manually controlled in each case. With the current system, image acquisition and the manual repositioning of the robotic microscope takes around 10-15 seconds, hence we are often forced to limit the size of the spatial grid or the number of images which, in turn, inevitably confines the ‘optical field’ of the final reconstruction and makes movement in the final image montage unpleasantly bumpy, ‘not continuous’, ‘not fine’. Manual camera control is yet another source of errors deteriorating the quality of the final image reconstruction montage. (It may happen that, in a given position, one only of the two cameras is shot, and hence in that position one member only of the stereoscopic image-pair will be available. Consequently, only a mono image is produced in that position, and it is impossible to generate its pair. Hence in this position one is obliged to ‘cheat’ and bring in the adjacent image-pair, that is, repeat images in the given grid position, which deteriorates the overall quality of the image montage. A further disadvantage in such cases is that when, in the case of multi-layer mapping, the appropriate pair of images is made precisely at the same point of the next layer, a misalignment will occur between the ‘spoiled’ and the ‘correct’ layers in the same spatial position. Owing to the rather basic software of the microscope, as of now, it is not possible to return to the same position after having ‘spoiled’ something, and to repeat the image acquisition process in that position. Hence we either accept that the image was spoiled and replace it as indicated above with an adjacent pair, or we start image acquisition anew, meaning the repetition of 40-50 minutes of work. The longer we work, often 30 to 40 hours, the more frequent this type of error will become as attention wavers and fatigue sets in.

The currently available image reconstruction method was developed on the basis of two known programs although the solution itself is absolutely unique. QTVR image files with so-called .MOV extension can be generated and displayed with the help of commercially available programs. Since no application allowing the similar interactive display of multi-layer image stocks was accessible on the market, we have developed a method for linking and displaying images originating from identical positions of the virtually stacked image grids. Innovatively, instead of using an interlacing file to show the stereoscopic image stock, as is common for the accessible software products, the images shown to the viewer were generated by downloading left- and right eye-piece pictures juxtaposed in one file.

The objective of the invention was to satisfy the demand for real-time 4D image acquisition of even in vivo surgical approaches with the help of preferably an equipment that is easy to transport and mount, allowing free navigation in the recording space and time of the recorded image material in case of subsequent retrieval or playback.

There was a huge demand for separating somehow the entire technology from the robust and expensive robotic microscope characterized by the disadvantages described in detail above, and for making it automatic, so that it should be easily accessible to others, too. Hence the objective was to develop a dedicated device expressly for image reconstruction technology, but suitable, if need be, on the basis of its stereotactic features, for replacing the manually controlled stereotactic structures that have been accessible until now.

Although the reproduction of exactly and precisely the same position requires robotic technology, a system has to be developed that is capable of the precise spatial positioning and targeting of cameras (or other dedicated devices), and is smaller, lighter and better adapted for this purpose than the system using the MKM robotic microscope.

As a matter of fact, neither is the MKM microscope itself necessary, as its objective system is used exclusively for image acquisition, but neither can that equipment be used for surgical purposes during shooting (scanning). In the course of image acquisition, the objective covers a useful area of approximately 50×50 cm i.e. 20×20′ only. If the camera can be moved securely, without vibration, throughout this space, the result will be the same as with the MKM-STN system.

In this case, too, the operation must be stopped for the time of the scanning and be resumed afterwards. This is perfectly feasible by using a dedicated structure brought into the operative field exclusively for the period of the scanning. Hence, preferably, the console should be removable from the operative field at any time.

The aim set was achieved, on the one hand, by a moveable console for holding an image acquisition or medical device, in particular for the purpose of brain surgical interventions, comprising a holder fixing the device immovably and a supporting arm including the holder, wherein the holder is designed as a single- or multi-member holder; furthermore, the holder is connected to a table in a revolving and hinged manner and associated with at least one moving means moving it relative to the table; the supporting arm and/or the moving means is associated with position or movement sensors; and at least one moving means and the position or movement sensors are connected to a control unit. According to the invention the supporting arm includes an arched section; the holder is moveably mounted in the arched section; the radius of the arched section exceeds the radius of the phantom circle encompassing the target to be observed or handled, and the centre of rotation of the radius falls into the region of the centre of the circle; the arched section is tiltably connected to a further supporting arm section, guided in a vertically movable manner, said supporting arm section is connected to an assembly consisting of a supporting arm section guided in a way allowing a movement parallel to the longitudinal direction of the table and a supporting arm section guided so as to allow movement perpendicular to the longitudinal direction of table.

Alternatively, the supporting arm includes an L-shaped section, and the holder is moveably mounted on the horizontal segment of the L-shaped section.

The objective of the present invention was achieved, on the other hand, by a method for the 3D scanning of, in particular, approached parts of the human body, and the electronic recording and reconstruction of information regarding the scanned object surface, in the course of which image recordings are made of the object surface in predefined area units and along a predefined trajectory; individual image recordings are stored retrievably in a database, so that each image is also assigned a sequence datum referring to the sequence of recording; in the course of reconstruction, individual image recordings are displayed after retrieval based on the sequence data; and image acquisition takes place in the course of the approach of the object surface, on one continuous object surface layer after the other, consecutively. The novelty of this solution lies in that individual images are stored not only with the matching sequence data, but also with their respective position and/or recording time parameters specified relative to a predetermined reference point, and reconstructed images can be displayed on the basis of retrieval based on any of either the sequence data, or the position parameters or the recording time parameters.

Preferred embodiments and implementations of the present invention are disclosed in the dependent claims.

### ADVANTAGEOUS EFFECTS

Similarly to the known solutions, the proposed console and method is suitable for stereotactic approaches, but it also supports 4D image acquisition and reconstruction. The fact that the apparatus is easily portable (in hand) makes it even more suitable for the 4D recording of surgical operation stages, because it can be mounted, as desired, on operative tables in several operating theatres, or several pieces can be used in one institute. Moreover, the expensive optics is replaced by easily accessible cameras suitable for digital image processing.

Since the trajectory parameters are arranged into approaches and approaches in turn into projects, it is possible to identify different trajectories for several approaches within one and the same project for the purpose of image acquisition. This arrangement allows to change over from one approach to another at any time, and consequently makes it possible to compare, in the final image reconstruction montage, not only identical stages of the approaches, but also their identical coordinate depths.

The method developed earlier was limited to the reconstruction and display of adjacent images in a multi-level image grid, and could not reconstruct and show the said images on the basis of their spatial acquisition and spatial coordinates, and hence it was not possible to view images recorded in any spatial position, only if one ‘got there’ in the course of the process of image movement.

The new method reconstructs all images according to their coordinates, i.e., in the order of their acquisition. This is important because this solution allows free navigation at will among the images, and contour projection, too, is solved more easily, by simply loading the masks of the image selected actually in the 3D image controller.

### DESCRIPTION OF DRAWINGS

In what follows, we shall describe the invention in more detail with reference to the enclosed drawings illustrating some exemplary embodiments of the proposed console and a possible implementation of the proposed method, whereas

FIG. 1 shows a possible embodiment of the console according to the present invention, in use, under operational conditions,

FIGS. 2a-2b explain the possible adjustable area of image acquisition with the help of the proposed console,

FIG. 3 shows a possible embodiment of the arched section of the supporting arm in side view,

FIG. 4 shows a possible embodiment of the holder guided along the arched supporting arm section according to FIG. 3,

FIG. 5 shows the further supporting arm section holding and moving the arched supporting arm section, and the moving means,

FIG. 6 shows a possible solution of the supporting arm section connection realizing the 3D movement required for the positioning of the arched supporting arm section,

FIG. 7 is a schematic illustration of the holder secured on the arched supporting arm section and the camera placed on it,

FIG. 8 shows the arched supporting arm section, the holder and the camera according to FIG. 7, with the camera moved to the end of the arched section,

FIG. 9 shows a possible implementation of the separate moving means rotating the camera secured to the holder,

FIG. 10 is a schematic illustration of the supporting arm comprising two linear sections meeting in an angle, replacing the arched supporting arm section,

FIGS. 11-13 show other possible embodiments of the console according to the present invention, in use, under operational conditions, and

FIGS. 14-23 show flowcharts of possible implementations of major phases of the proposed method.

### BEST MODE

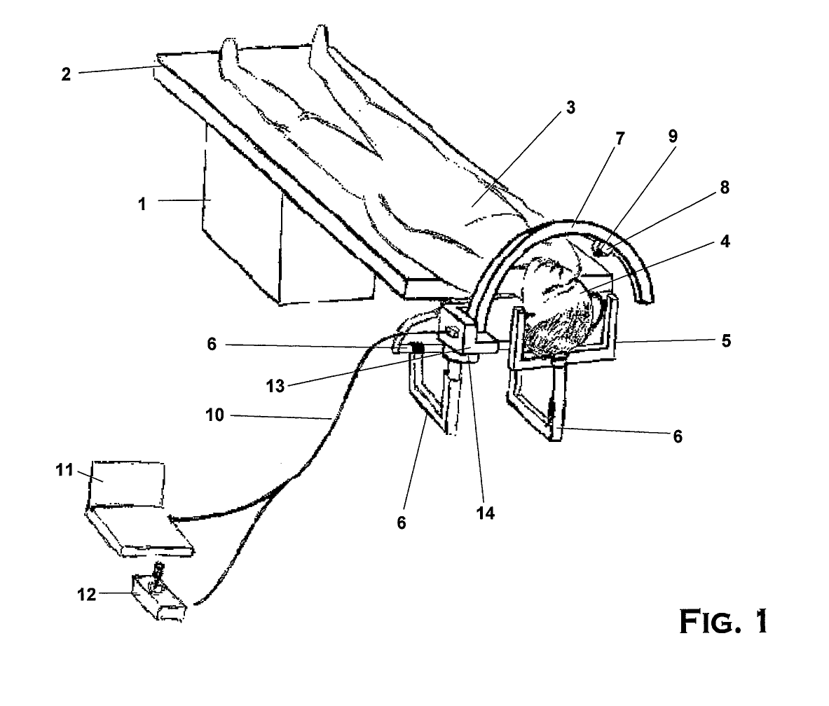

The movable console according to the entire invention comprises two main parts, namely
a stereotactic console capable of positioning the image acquisition system, the camera, on the basis of spatial coordinates. If the device is not an image acquisition unit, but a dedicated stereotactic device, then the holder also serves the targeting and positioning of the camera (see FIG. 1); and
a method for the coordinated control of the console and the image acquisition device, as well as for the storage, processing and display of the recorded images, and for storing and re-setting of the scanning parameters. It is possible to control the console's holder manually, too, using a joystick.

The following criteria were taken into account in designing the console:
1. The arched section will be easily removable from the operative field at any moment of the surgical or dissection process, and will allow that another accessory device, e.g. operative microscope or X-ray equipment, be pushed in by its side at any time.
2. It will not disturb the traditional arrangement of operative instruments in the surroundings of the arched section, that is, it will be available for use in an area that is ‘not bound’ yet
3. It will be easy to clean and the parts will mostly be covered, as far as their movement allows it.
4. It will cover greater target area than the known system.
5. It will be light.
6. It will be of a small size, portable even in a handbag.
7. It will ensure the fast and continuous movement of the camera or holder, with minimum vibration of the structure in the course of the movement.
8. The essence of this design will be to allow the positioning of the camera itself at any previously marked point in the area within the limits defined by the arched section, and its movement around that point, over a spherical surface, so that the ‘overview’ of the camera (holder) of the target should not change, not even while in motion. This design will allow programming the movement not only on a spherical, but also a cylindrical surface, or to construct an image grid, as desired.
9. The spatial coordinates of the holder of the console will be known in every position from calculations based on the moving parts of the console, the length and angle of displacement of its units.
10. It will be possible to provide the cameras with PAL® optics, allowing to take full panorama pictures in each position, which can be unpacked, i.e. interpreted, later on by the software program, on the basis of the parameters of the optics. Hence it will possible to make a full panorama picture not only in one, but in every position, at any moment of the spatial scanning process.
11. A joystick will also available for the positioning of the holder of the console.
12. Image viewing will be possible on the same hardware platform, which can move not only the console, but also the final image reconstruction montage.

FIG. 1 shows the application, in surgery, of a possible embodiment of the console according to the present invention. The description will mainly use the term ‘operative table’, but, obviously, this may mean any other surface upon which the organ that is the subject of the intervention can be put or that will support it. In the present case, the console is secured to the narrower end of table 2 placed on stand 1, the end where the patient's head would be. Head 4 of patient 3 lying on table 2 is fixed in position in the usual and known way in therapy by head frame 5, placed on support 6. The supporting arm includes several supporting arm sections, fastened in a relative rotatable tiltable and slidable manner. From the point of view of the invention, the most important section of the supporting arm is arched section 7, to which in the present case camera 9 is connected through a holder 8. Instead of camera 9, however, other devices, instruments or tools to be used in the intervention concerned could also be secured to holder 8. The supporting arm is connected either wirelessly or, as in the present case, through cable 10 to a central unit realized, for example, by computer 11, and to the moving means, in the case shown here joystick 12, moving camera 9 and individual supporting arm sections of the supporting arm into their respective desired positions. Arched section 7 embedded in moving means 13 rests upon revolving base 14.

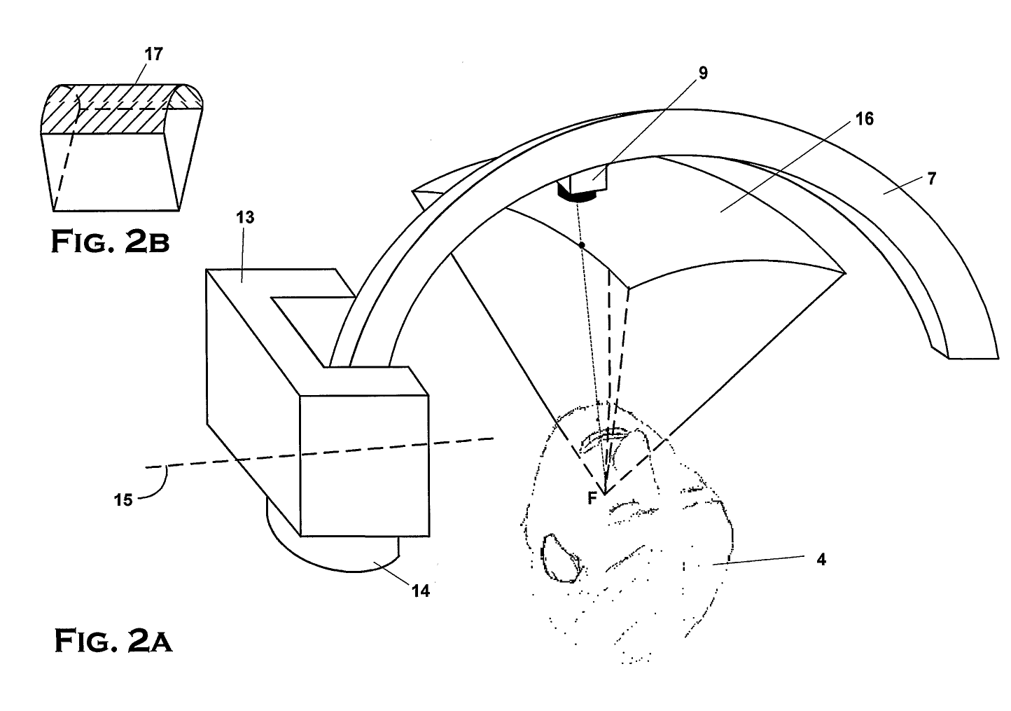

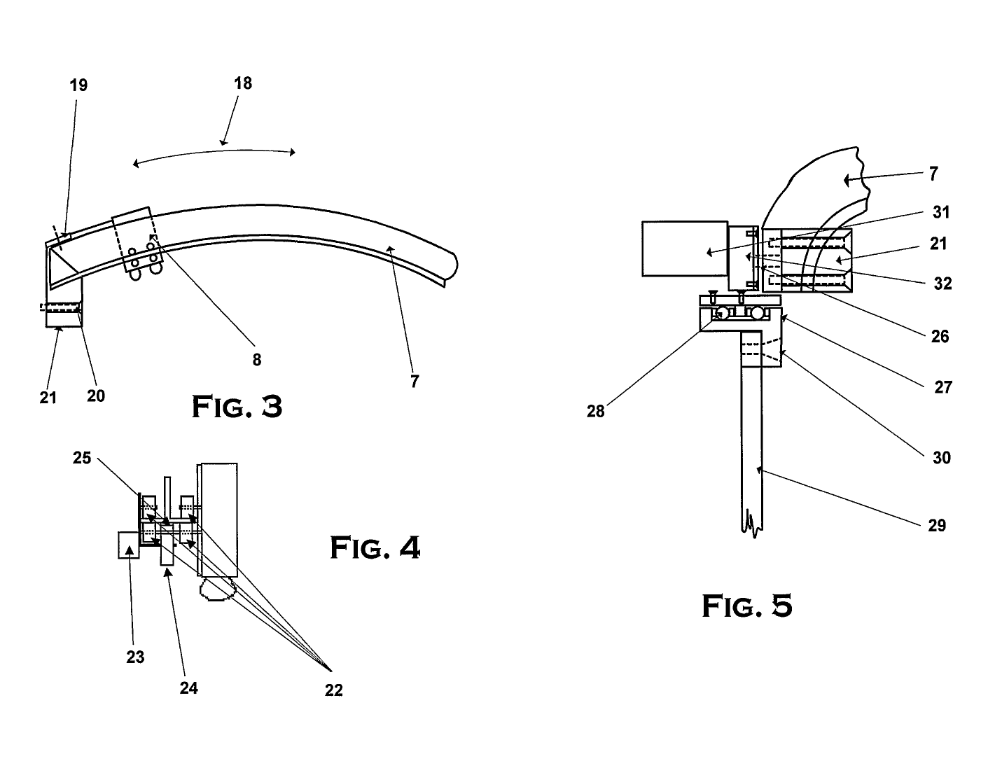

FIG. 2a shows an important detail of the arrangement according to FIG. 1 on a larger scale. As can be seen, by moving camera 9 along arched section 7, and by tilting arched section 7 itself around rotation axis 15 indicated in dotted line in the figure, it is possible to scan with camera 9, with a degree of resolution chosen at discretion, a spherical surface segment 16, the radius of which is defined, in the present case, by the phantom centre point within head 4 of the patient (brain surgery), to which the focus of camera 9 is set during image acquisition, while scanning the individual layers and progressing from the body surface to the phantom centre.

FIG. 2b shows a variant whereas arched section 7 is not tilted to and from relative to rotation axis 15, but is left in its original vertical plane, and by displacement along the other supporting arm sections, in the present case those parallel with table 2, a cylindrical surface segment 17 can be scanned the symmetry axis of which is parallel with the longitudinal axis of table 2 or, by displacement parallel with the shorter side of table 2, images can be acquired of the cylindrical surface segment 17 the symmetry axis of which is perpendicular to the longitudinal axis of table 2.

FIG. 3 shows arched segment 7 in side view, and as can be seen, holder 8 is placed on arched section 7 having a profiled cross-section as a moveable carriage, guided in arched section 7 so that it can be pushed in the movement direction indicated by arrow 18. Cable-holding spool 19 is secured on arched section 7, and arched section 7 itself is fastened to a supporting arm section serving as arch-fixing support 21, with screws 20.

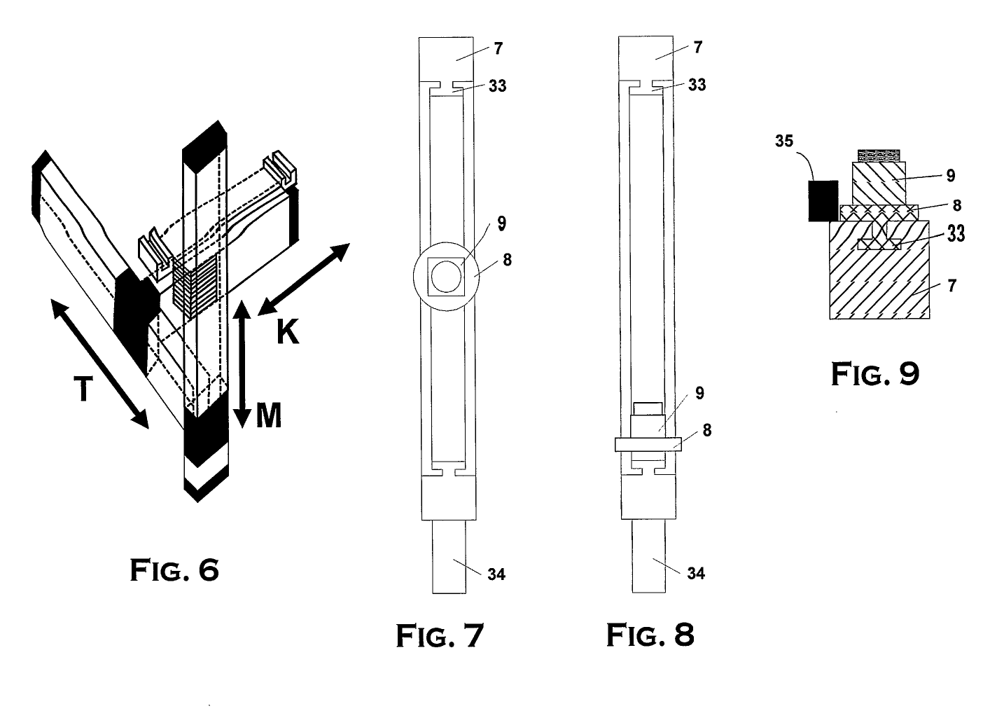

It is essential that image acquisition should produce images of adequate resolution, one of the preconditions for that being that the recording device be set correctly and settings should not change during recording. Therefore, camera 9 fastened to holder 8 should move along arched section 7 at no-clearance. This can be ensured, for example, in the manner shown in FIG. 4. The cross-section shows that arched section 7 is designed as a T-shaped guide, upon which holder 8 rests through running wheels 22. No-clearance movement of running wheels 22 can be ensured in the manner known in the art by their pre-loading by spring power. If holder 8 does not travel on running wheels 22, but is, for instance, in slide contact with arched section 7, then the no-clearance movement of holder 8 can be ensured by flexible elements embedded in it. Holder 8 is moved along arched section 7 by a special moving means, in the case depicted here a step motor 23, on the axis of which cogwheel 24 is fixed, so that the movement of camera 9 is ensured by the co-operation of cogwheel 24 and cogged arch 25, depicted symbolically here, constructed on arched section 7.

Of course, in contrast with the example shown in FIG. 4, it is also possible, instead of designing arched section 7 as a profiled, e.g. T-shaped rail, to make it thicker, a solution enhancing rigidity, and to make a profiled, e.g. T-shaped groove in it into which the appropriate complementary-shaped part of holder 8 will fit. The no-clearance movement of holder 8 can be ensured, for example, in the manner referred to above. The only restriction applicable to the material of holder 8 and of arched section 7 is that it should be a material approved for utilization in health care and that it should guarantee sufficient mechanical solidity, i.e. allow that parts revolving or sliding against one another should operate together permanently and reliably without special lubrication. The material of running wheels 22 or cogwheel 24 might be polytetrafluorethylene, that of cogwheel 24 and cogged arch 25 beryllium bronze or some other similar common material.

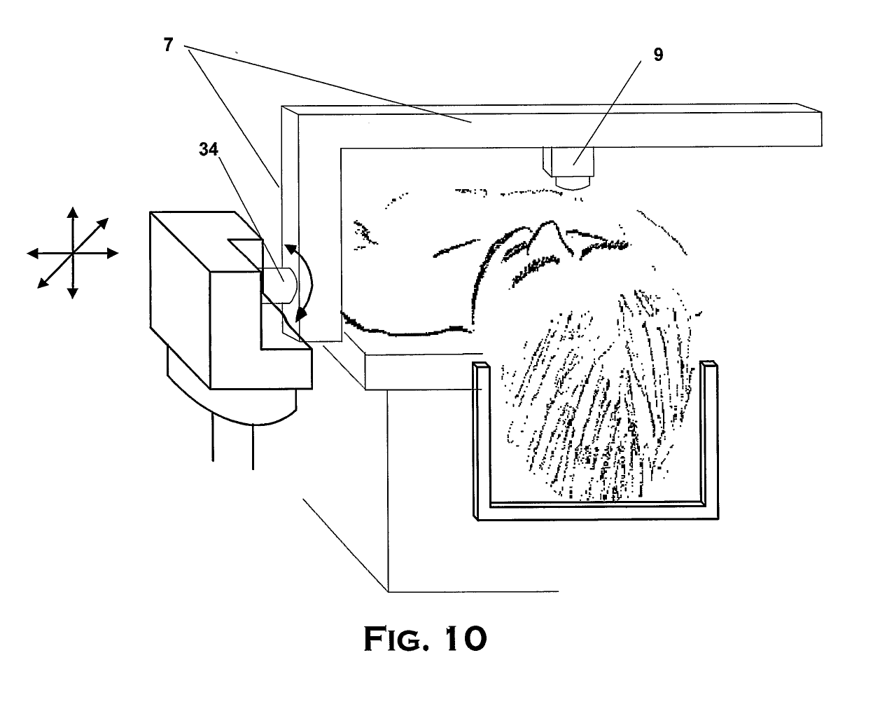

FIG. 5 shows a scheme of the further supporting arm section holding and moving arched section 7, and the associated moving means in a possible embodiment. As can be seen in FIG. 5, one end of arched section 7 holding camera 9 indirectly is fastened, with the help of arch-fixing support 21 and screws 20, to one leg of L-shaped intermediary piece 26. The other leg of intermediary piece 26 is connected to a console 27, attached to the vertical section 29 of the supporting arm through bearing 28, fixed for example by screw 30. Intermediary piece 26 is associated with a rotating means responsible for the rotation/tilting of arched section 7 about rotation axis 15. Rotation axis 15 depicted in FIG. 2 is defined by the position of arch/fixing support 21. The rotating means comprises a step motor 31, which may be connected to arch-fixing support 21 of arched section 7 either through a transmission unit 32 as in the case shown here or directly.

FIG. 6 shows an example of the design of the supporting arm ensuring the desired 6 degree of freedom movement of the arched section 7. As can be seen, individual supporting arm sections, realized, for example, in the given case, by linear drive mechanism Type LZBB 085 manufactured by SKF, provide for movement, parallel with the longitudinal axis of table 2 and indicated by arrow T, for a movement in a plane that is horizontal to it and indicated by arrow K, and for the vertical movement of section 29 of the supporting arm, perpendicular to the previous ones and indicated by arrow M. Individual supporting arm sections should comply with the requirements of adequate mechanical stability and vibration-free movement, satisfied by any linear drive mechanism, for example, as a matter of course, and facilitated by the very small mass of the last supporting arm section, namely arched section 7 together with holder 8 and camera 9 on it.

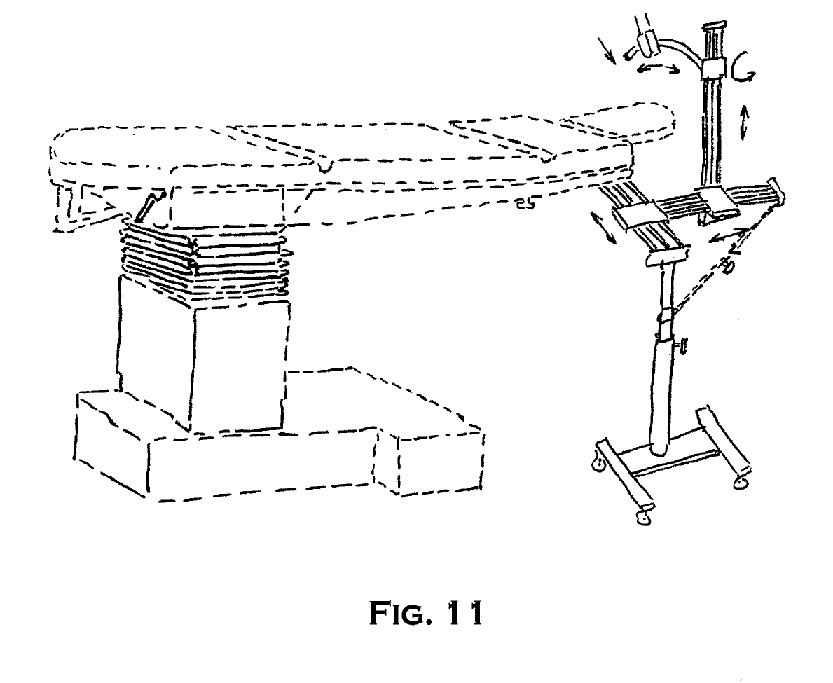

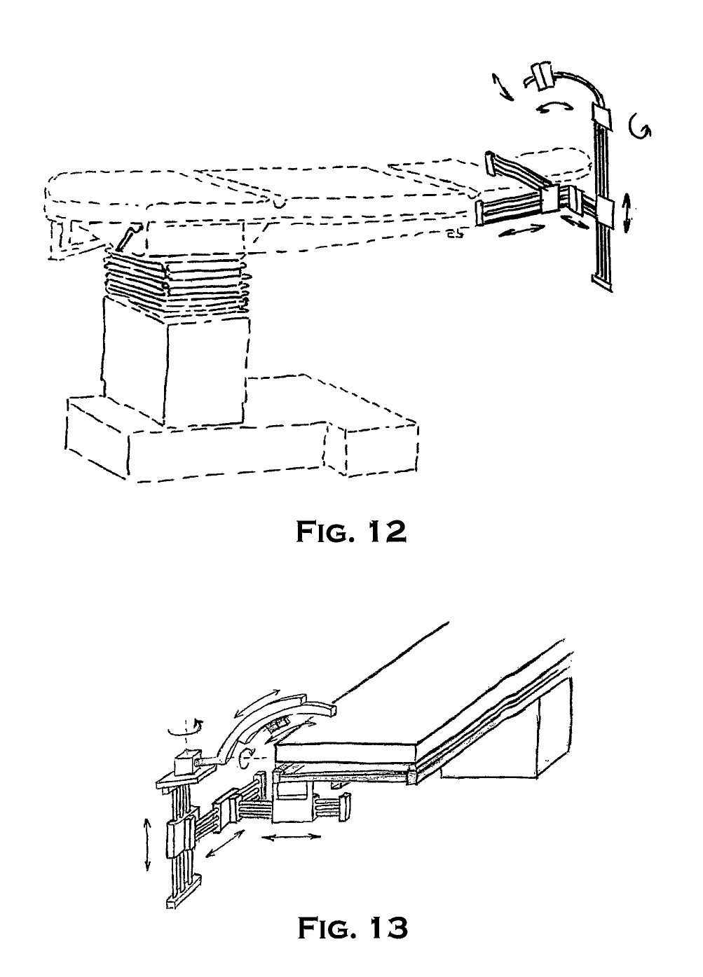

FIG. 7 shows a bottom view of arched section 7 designed as guide 33, with a T-shaped cross-section, securable by its axis 34, with camera 9 located in its middle part. FIG. 8 shows that camera 9 is moved by holder 8 to one end, closer to the holding point, of arched section 7, and thanks to arched section 7, the optical axis of camera 9 is different from that in the setting shown in FIG. 7.

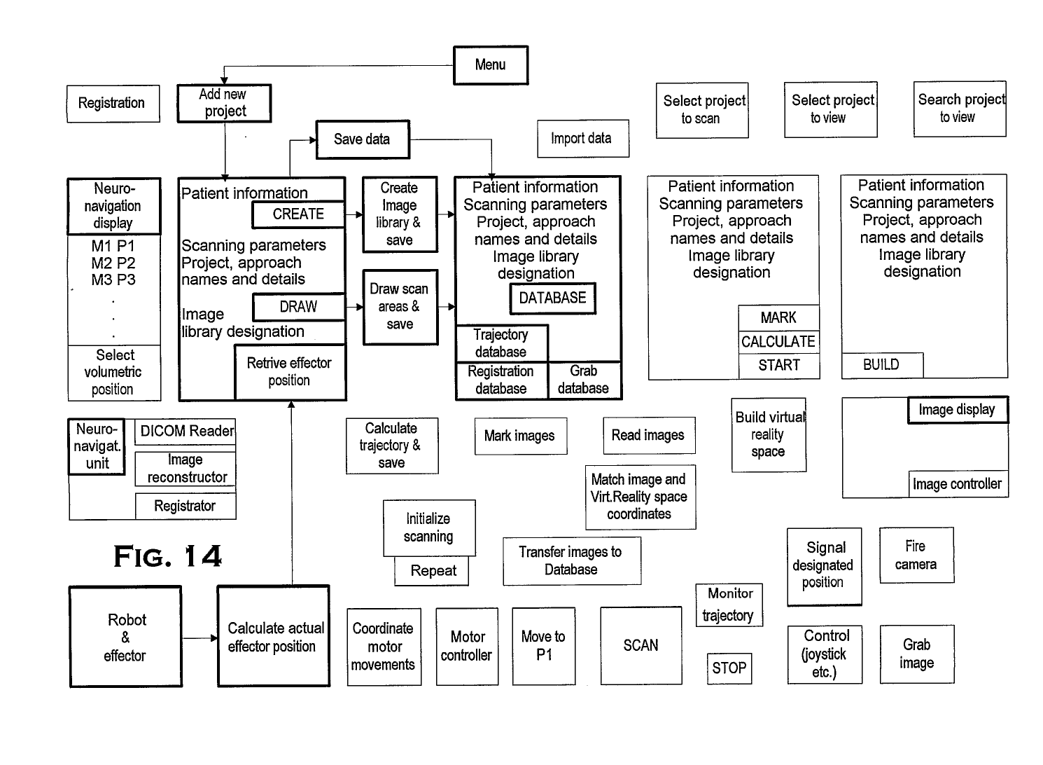

FIG. 9 shows in a somewhat larger scale the option whereas holder 8 guided along or within arched section 7 is equipped with a separate moving means 35, in moving connection with support plane 22 holding camera 9, and allowing that camera 9 to rotate or be rotated about its own optical axis. This is advantageous because it makes it easy to view the area under observation with the already positioned camera 9 from the direction that is most advantageous for the person carrying out the intervention.

FIG. 10 shows a variant wherein, as opposed to what is suggested by its name, arched section 7 consists of two parts meeting in an angle, e.g. of 90 degrees, and holder 8 with camera 9 is embedded in the section located above table 2, parallel with it, i.e. horizontally, in a way allowing sliding movement. It will be easily understood that the design shown in this Figure, with the said supporting arm section still embedded in a manner allowing rotation around axis 34, will allow to view/scan not a spherical surface segment 16, but a cylindrical surface segment 17. If the console is mounted as shown in FIG. 10, that is, moveably along the longer side of table 2, a cylindrical surface segment 17 transversal to table 2 can be scanned, whereas if the console is mounted moveably along the shorter side of table 2, then a cylindrical surface segment 27 that is parallel with table 2 can be scanned.

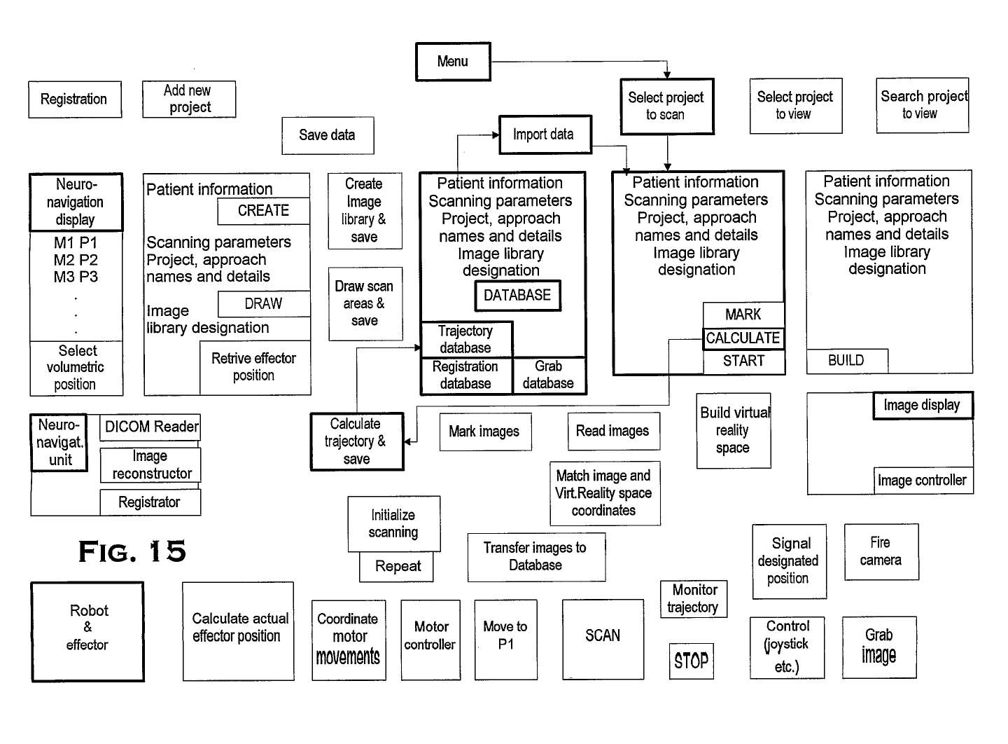

FIGS. 11-13 show some examples of further possible embodiments of the console according to the present invention and its arrangements. FIG. 11 illustrates a possible variant whereas instead of being secured to table 2, the proposed console is realised as a independent, separate console. This solution has the obvious advantage of making it much easier to move the console to other premises or remove it if no longer needed to some place where it does not hinder the surgical approach. In the preferred exemplary embodiment, the horizontal section of the linear moving mechanism of the console, parallel with the shorter side of table 2, is secured directly to the console, with a further section, also horizontal, parallel with the longitudinal side of table 2, being connected to this section, and a third, vertical, section of the linear moving mechanism, to which arched section 7 is connected for example in the manner shown already, being connected to the second section.

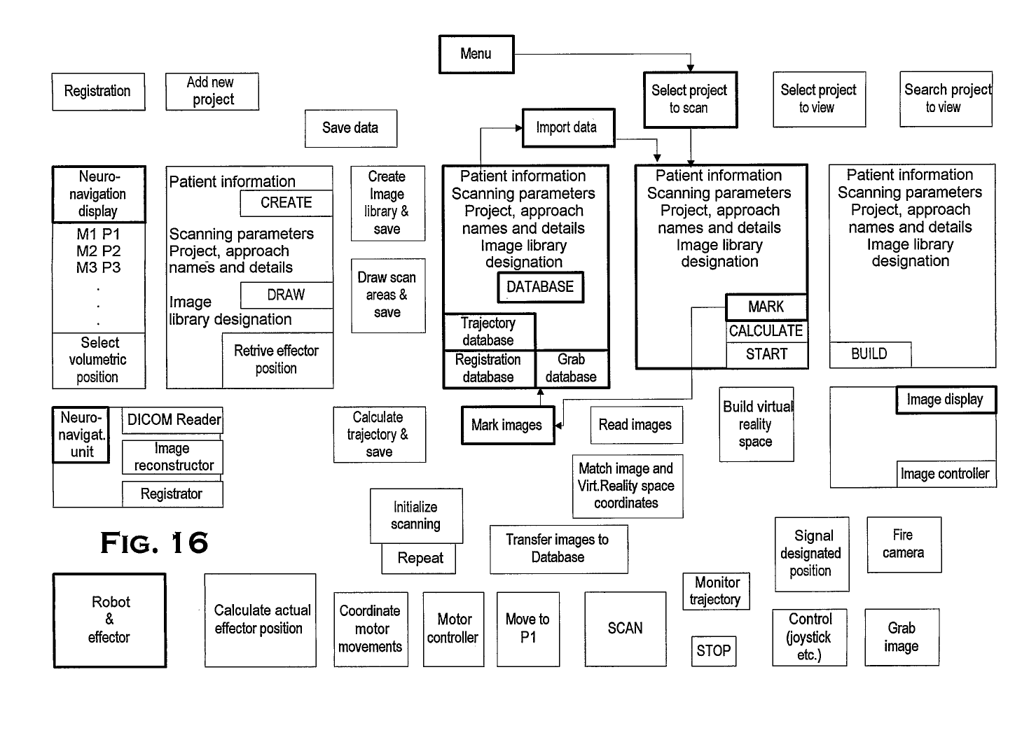

In comparison, in the embodiment shown in FIG. 12, the linear moving mechanism is fixed to table 2, and this arrangement allows 3D movements of a different order than the arrangement shown previously, and hence the console is positioned, even in closed state, differently in the region of table 2 than in the case of the embodiments shown in either FIG. 11 or in FIG. 13.

In the case of the embodiment shown in FIG. 13, the console is mounted in a fixing cradle at the edge of the shorter side of table 2, representing that section of the linear moving mechanism which is parallel with the shorter side of table 2, and the second section, parallel with/moving along the longer side of table 2 is connected to that section and then the third section, which can be moved vertically, is connected to the second. For this embodiment, we have also shown another design, preferable in some cases, of arched section 7, whereas the arched section is not complete, i.e. going the full length of a circle, as shown so far, but only half that length, but realized telescopically, so that the lower part can be pulled out to obtain a complete section arc. Of course, holder 8 is fastened to the lower section part, and can be moved along that, and the desired position can be attained not only by pushing holder 8 along arched section 7, but also by pulling out the lower arched section part.

The embodiments shown and outlined above are only examples of how the movement options of the various supporting arm sections can be adjusted to the possibilities offered by the premises ever, and how the size of arched section 7 can be reduced, that is, measures ensuring that the proposed structure should not hinder the movement, placement and work of the person carrying out the intervention.

As it can be seen, the console itself comprises several parts. Each part can, for example, be driven by electric motor, and the position of holder 8 of the console is detected by sensors. Sensor feedback makes the position of camera 9 relative to the origin of the absolute coordinate system of the console known at every moment. In the example shown here, the console consists of arched section 7 arching over the operative field and of a unit fixing and moving it. Holder 8 running in longitudinal direction along arched section 7 moves constantly around the origin of arched section 7, and ‘views’ the scene perpendicularly to the origin of coordinates. It is equally possible to attach to holder 8 a camera 9 or a stereotactic manipulating device. In order to facilitate the adjustment of the ‘overview’, the camera 9 or the stereotactic device itself is mounted on holder 8 by inserting a rotating plane in between, provided that it is necessary to make the so-called ‘overview’ adjustable in the course of the movement. This fixing and moving unit is designed so as to allow to tilt the arched section 7 diametrically around the main plane of a half-circle, and the entire arched section 7 can be moved/positioned forward, backward, sideways, up and down. For the purpose of setting an intersection main plane of the arched section 7, the fixing and moving unit is designed so as to make that option adjustable both electronically and manually.

Arched section 7 is not necessarily of such small size. If necessary, a similar technology can be used for example to record the assembly of vehicles, for the purpose of archiving or documentation. In this case, the console may be the size of a room, big enough to place a car under it for the purpose of recording the assembly phases, said recording applicable later on in the fitting workshops, too.

The console carries the camera 9 all over a scanning surface, the so-called trajectory, making pictures (stereoscopic picture pairs) in each position of the trajectory with camera 9 activated each time a point of the trajectory is reached. After having determined the recording sequence and the grid step, the pictures are processed by the image reconstruction facility, on the basis of their spatial coordinates.

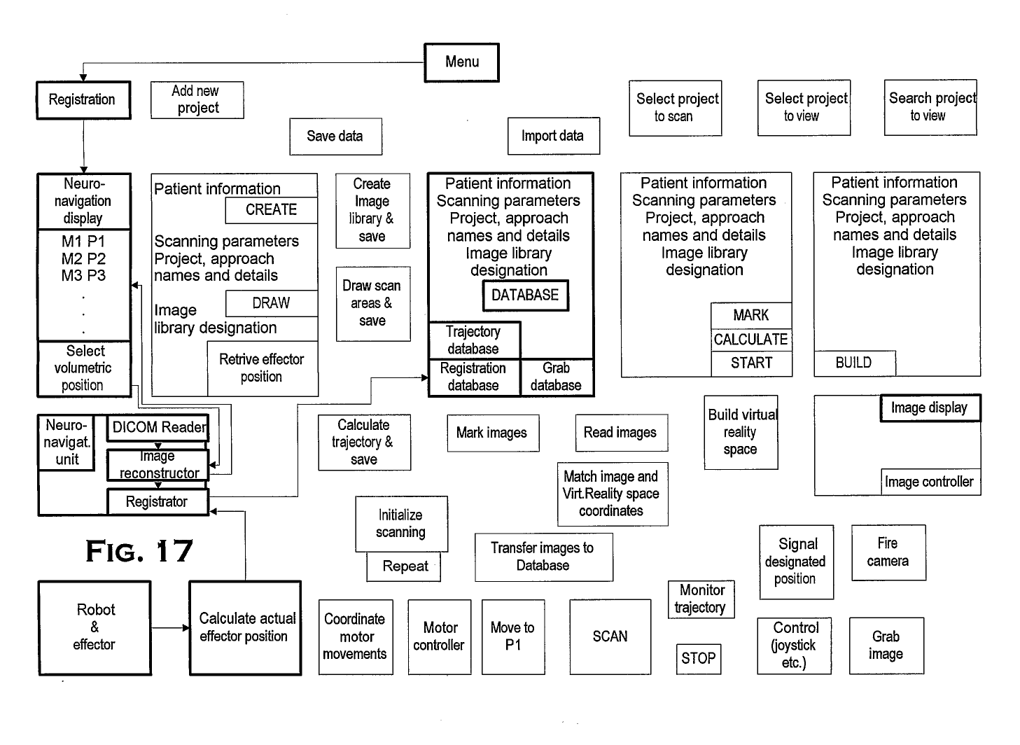

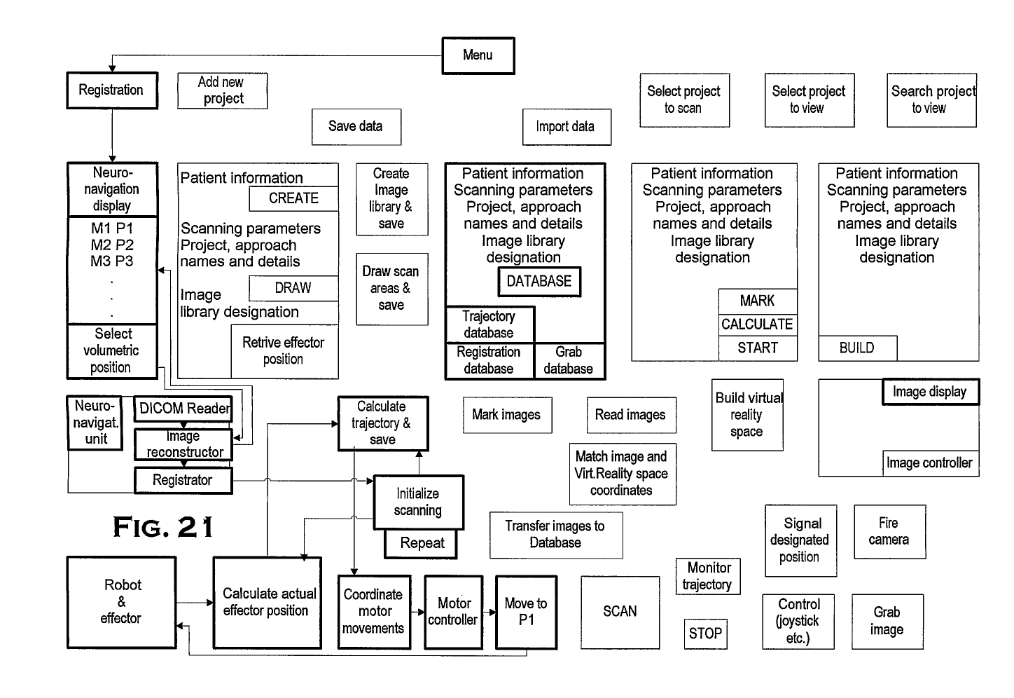

In what follows, we shall describe in more detail the proposed method of the present invention, with reference to an exemplary implementation. FIGS. 14-23 show the respective stages of the method in bold. The approach itself is selected either on a rotating head or on the head reconstructed from the DICOM file. The scanning pattern can also be generated from the volumetric data set, so that camera 9 is moved by the image controller, and take up the selected position accordingly.

The method consists of several major units, i.e. modules:
Spatial position planning module;
Image reconstruction module;
Console controlling module;
Neuro-navigational module;
Stereoscopic image display module.

FIG. 14 shows the first main phase of the method: add new project.

A sub-process to be launched is selected under this menu. Data on new patients will be added here. A window will be displayed for setting various parameters regarding the patient and the desired approach, respectively. Hence the following can be added here: personal data of the patient, data regarding the disease, the place and manner of saving the images to the database, parameters required for scanning, scanning resolution. Scanning parameters are set on the basis of the place or time coordinates issued in the course of the manual, joystick-based or voice-controlled positioning of camera 9. Once the data are set, they are saved to a database.

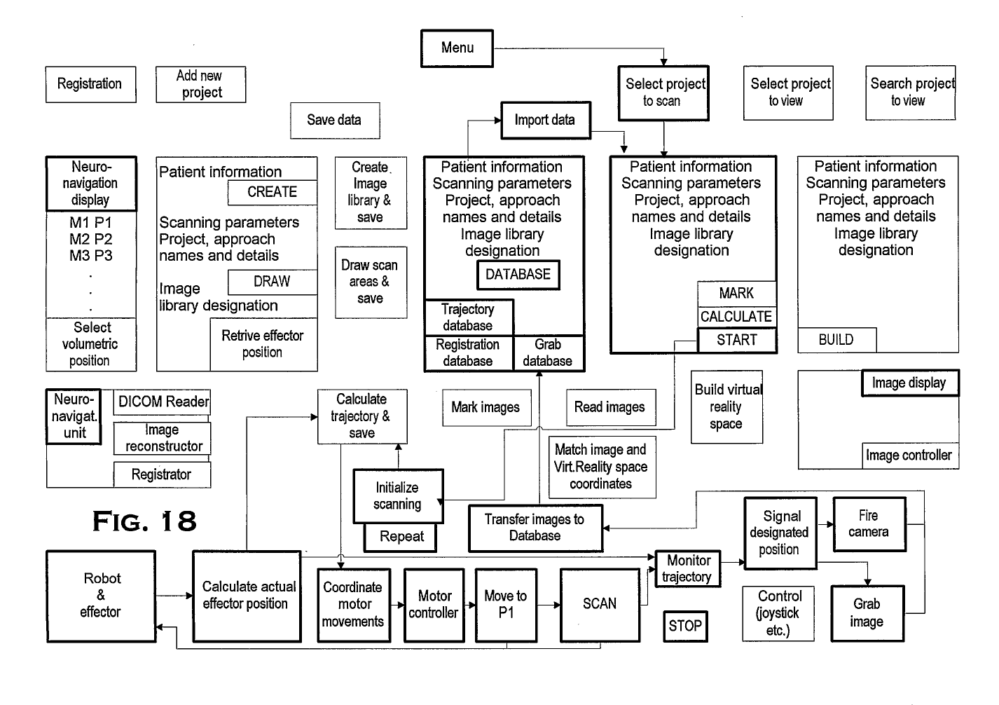

FIG. 15 shows the subsequent major phase of the procedure: registration.

The preconditions of this command are the following:
preliminary patient data input;
volumetric data set of the patient.

After having added the patient's data, the user will choose whether to carry out the approach with or without the support of the neuro-navigational equipment. If a volumetric data set is available, patient data input is followed by importing the volumetric data, which may be available in DICOM file format, through a reading device capable of reading and interpreting this file format. Import is followed by the 3D image reconstruction of the volumetric data set, and the result is displayed. The user may select points on the display device as desired while browsing freely in this 3D data set. Since the markers fixed previously to the patient's head will appear in this volumetric data set, too, they can be designated manually, too. After designation, each marker is assigned a holder position, so that the holder is set on the marker at the top of the patient's head, and the distance between the market and the holder is calculated using, for example, the auto focus function of camera 9. The spatial position of camera 9 can be determined at any time by the command ‘Calculate Actual Effector Position’ calculating the spatial position of the camera 9. After having assigned each marker the matching holder spatial position, the actual geometric position of the patient is calculated, the same as the divergence between the two data sets, the latter being accepted provided that it is within the previously fixed error limit. Subsequently, the registration keys, that is, the marker and spatial position coordinates, are saved with other pieces of information on the same patient. Hence it is not necessary to save a DICOM volumetric data set for each person and e.g. with the import of the DICOM file and the re-setting of the registration keys, registration can be done again, and the volumetric data set and the images identified as trajectory points can be matched at any time.

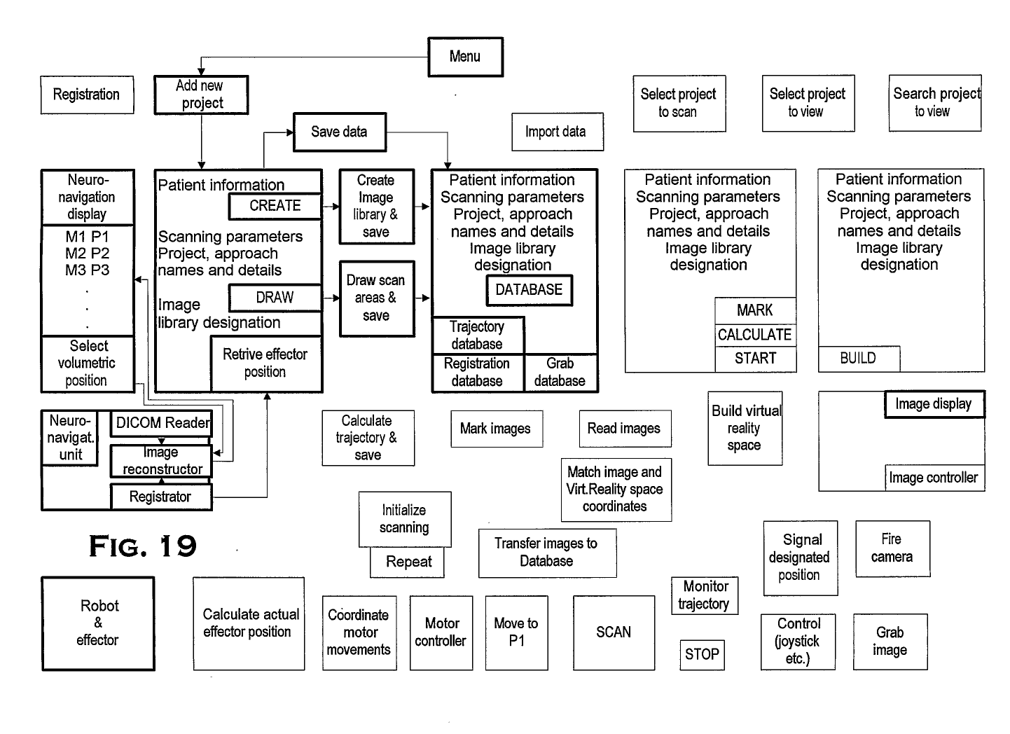

FIG. 16 shows the subsequent major phase of the procedure: stereotactic targeting.

The process is similar to the feature offered by the well-known neuro-navigational equipment. After registration, a position can be marked in the volumetric data set at will. Its volumetric coordinates get ‘translated’ in the registering unit, to provide a point that can be interpreted by the control unit, too. Information originating from the registering unit then activates the ‘initialize scanning’ command, and as a result, the system calls in the actual position of camera 9 to issue the command ‘Calculate Actual Effector Position’ and calculates the trajectory required for movement from the actual spatial position to the desired point by activating the command ‘Calculate And Save Trajectory’. Subsequently, camera 9 is moved into the desired position by activating the commands ‘Coordinate Motor Motion’, ‘Motor Controller’ and ‘Go to P1’.

FIG. 17 shows the subsequent major phase of the procedure: calculate trajectory.

The preconditions of this command are as follows:
preliminary patient information input (add new project);
preliminary scanning parameter input (scanning parameters);
volumetric data set of the patient; and
registration.

After project input and registration, if necessary, every point of the trajectory is calculated on the basis of the already available parameters, and get stored, matched to the data of the patient, in the database. This function is selected in the menu in the window displayed upon the command ‘Select Project To Scan’ by issuing the command ‘Calculate’.

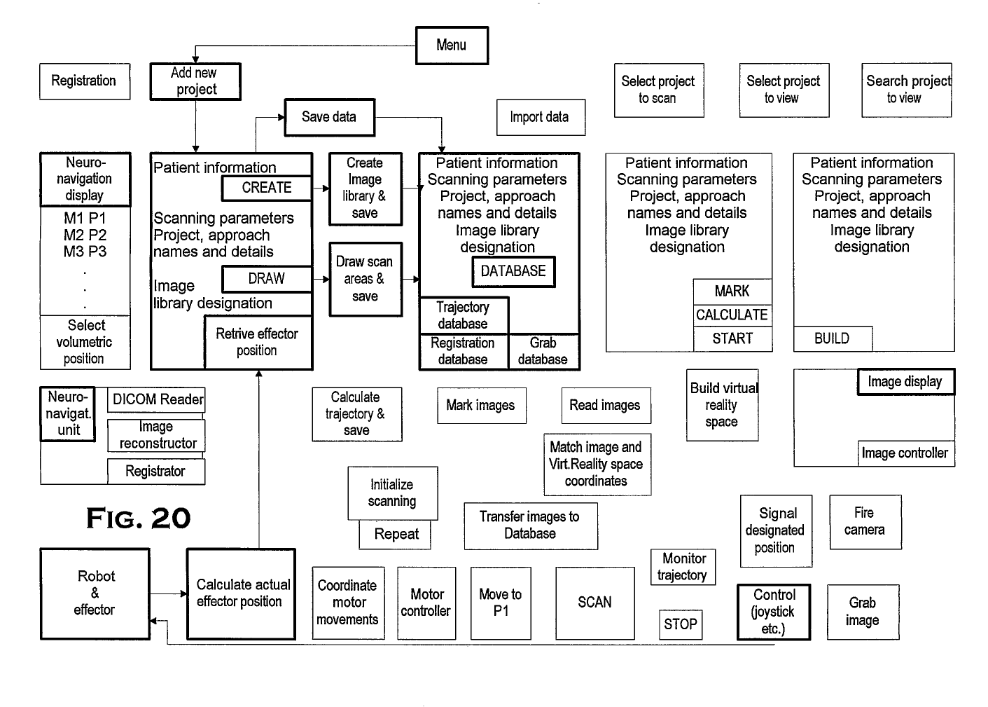

Alternatively, the trajectory parameters can be specified by the neuro-navigational unit, as shown in FIG. 18.

The preconditions of this command are as follows:
preliminary patient information input (add new project);
volumetric data set of the patient (DICOM file); and
registration.

Yet another solution is to set the parameters of the trajectory manually in case no volumetric data set is required, see FIG. 20.

After registration, the spatial position coordinates selected from the volumetric data set of the patient and converted into console coordinates by the registrator of the neuro-navigational nit will be used.

Registration (this time not by the manual positioning of the console) is followed by the identification of the positions required by the system for establishing the trajectory in the volumetric data set. In order to make the control unit of the console ‘understand’ the volumetric data, however, the latter must be fed to the registrator, where they are converted into the actual spatial position coordinates (all data should fall within the action range of the console, this is checked and a signal is given, should they fall outside it), then, by issuing the command ‘Specify Position Of Console’, they are matched to the settings requested by this system for the establishment of the trajectory, then, together with the patient data, they are saved in the database as registration ‘key’. Hence, with the help of the DICOM file, the registration, once done, can be reproduced any time, if image reconstruction requires the image reconstruction of the volumetric datum, too.

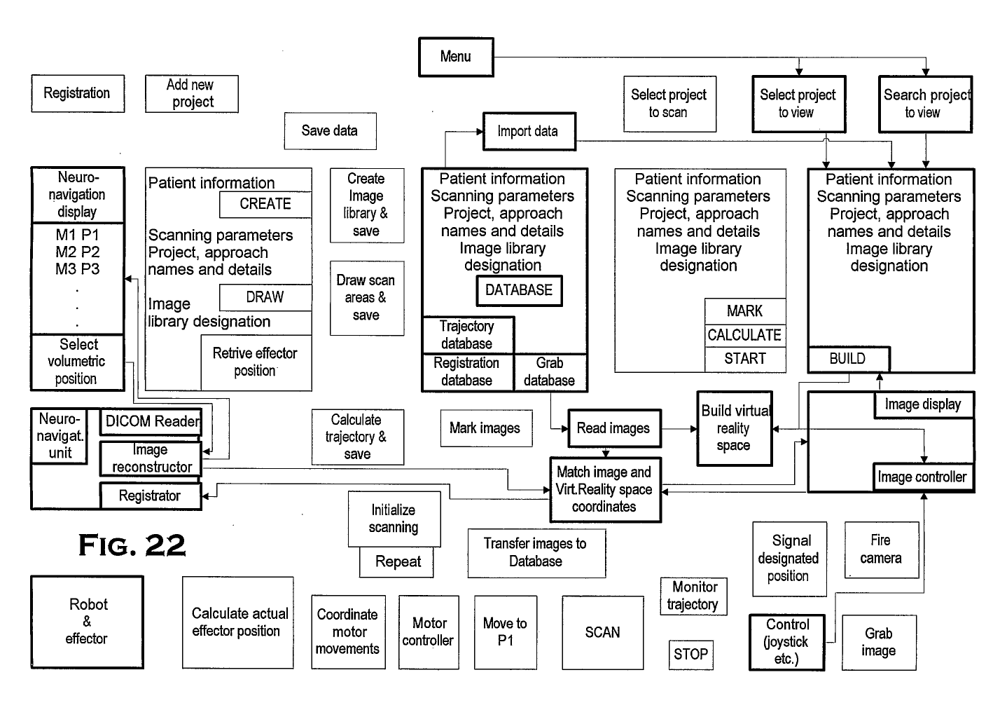

FIG. 21 shows the subsequent major phase of the procedure: selection of the project to scan.

The preconditions of this command are as follows:
preliminary patient information input (add new project);
preliminary scanning parameter input (scanning parameters);
either manually, e.g. with a joystick, or by voice command;
or by the neuro-navigational unit;
calculate trajectory;
mark images (assign spatial position coordinates to the images);
volumetric data set of patient;
registration.

After patient and scanning parameter input, registration and the calculation of the trajectory, the command ‘Select Project To Scan’ will take us to the window where the patient can be selected and then the ‘Start’ command launches the initialization of the process. In the course of initialization, the trajectory leading from the actual position of the holder to point P1 of the scanning trajectory is calculated, then the holder is moved from the actual position to point P1 of the scanning trajectory so that first the operation of the step motors is coordinated, then the commands are issued to the motor controllers, which will consequently move the holder to point P1, and then the scanning process will start from there. During scanning, the position of the holder, calculated through an actual holder position identification step, is known at every moment. Information is transmitted from here during scanning to the trajectory monitor, monitoring the established trajectory, and once the holder reaches the predetermined position, then, depending on whether a photographic camera or a video grabber is being used, an instruction is given to create an image or grab a frame (‘Fire Camera/Grab Image’). Once the picture is taken, it is saved to the image database either directly or after indication of the spatial coordinates of the trajectory point where it was taken.

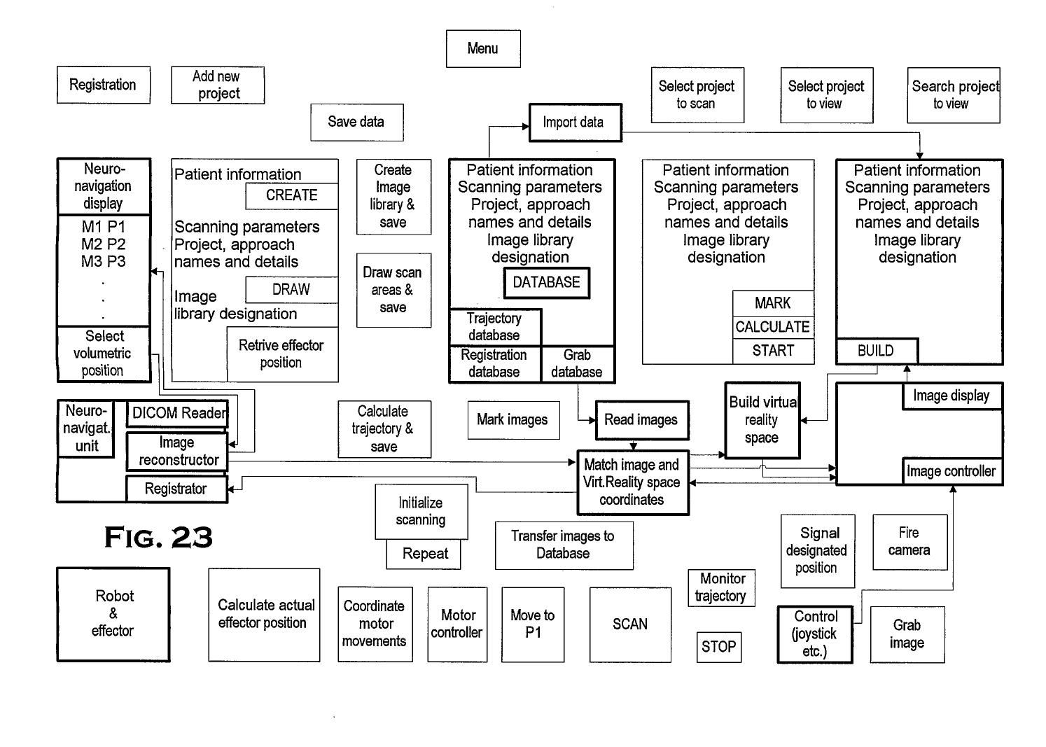

FIG. 22 shows the subsequent major phase of the procedure: unambiguous and unique marking of the acquired images.

The preconditions of the command are as follows:
add new project;
set trajectory manually/by the neuro-navigational unit;
calculate trajectory; volumetric data set of patient;
registration.

If the images are saved without indication of their spatial position, this piece of information can be added in retrospect by issuing the command series ‘mark images’, on the basis of the sequence of acquisition and of the trajectory points. Hence every image will be assigned the matching spatial position coordinates, albeit in a second round in this case. The above commands are issued in the manner detailed above, after the adding of the patient/scanning parameters and the repeated search of the data of the person concerned.

FIG. 23 shows a further major phase of the procedure: the selection or search of the project to be viewed.

The preconditions of this command are as follows:
add new project;
set trajectory manually/by the neuro-navigational unit;
calculate trajectory;
mark images;
volumetric patient data;
registration.

It is possible to search here not only by name, but by any of the parameters included in the database, as desired. The command ‘select/search project to view’ will select from the database the desired project or approach. The ‘build’ command initiates the spatial construction of the selected approach, and the system rebuilds the selected trajectory, and displays it in the image controller as a prism, so that only the X, Y, Z coordinates of the points are used for the prism-like display. Navigation in this image controller can be controlled by mouse, joystick or voice. Images matching the spatial points reached why navigating are retrieved from the image database/the neuro-navigational unit with the help of a facility matching the image and the respective spatial position. If the neuro-navigational unit is used, after volumetric patient data import and reconstruction, a volumetric spatial position is assigned to each spatial position with the help of the registration key, in which the volumetric image is reconstructed and shown simultaneously with the photographic image. The system works both ways, that is, a photographic image will appear upon moving/browsing in a volumetric image.

More precisely, when the spatial position is identified in the image controller by matching the image and the virtual spatial coordinates, these coordinates are converted in the registration unit. Prior to that, the volumetric data set imported through the DICOM reader and compiled by the ‘image reconstruction unit’ is displayed on the monitor. Hence a volumetric position is assigned to the spatial position converted by the registration unit, its images are reconstructed and then returned to the display unit for simultaneous display with the real-world image.

The project to view can be selected or searched from a display unit, e.g. screen, too. That process, too, can be tracked with the help of FIG. 23.

The process is similar to looking for the selected approach in the menu, with the difference that the approach is identified on the rotating head appearing on the display unit, on the basis of the regions indicated in response to the ‘draw scan areas’ command of the ‘add new project’ process. The regions in question appear while the head is turning around, and both the images and the volumetric reconstructed images, if any, can be called in, in the manner detailed above, by pointing to one of the numerous regions.

Spatial Position Planning Module

The module establishes the scanning surface or in other words the trajectory and calculates the spatial coordinates of every one of its points. The trajectory is most often a spherical or cylindrical surface segment, but it can also be a simple plane surface. The essence of the design is that it is suitable for setting any trajectory, i.e. scanning surface, whatsoever, within the limits, of course, of the scope of movement of the console, defined by the mechanical connections of the moving and non-moving parts of the console. The objective is to design the console so as to have a scope of movement allowing a minimum of around 45° of freedom in every direction relative to a vertical axis at the centre of rotation at the middle of the arched section. The parameters (spatial coordinates) required for defining the trajectory are set by calculation based on two types of input data (e.g. spatial coordinates originating from two types of units).

One option is to position the holder of the arched section manually or electronically (e.g. with a joystick), as the exact position of the robotic parts is relayed at every moment by the position sensors, and from that, it is possible to calculate the spatial position coordinates of camera 9 (its holder) within the coordinate system of the console, relative the latter's origin, at any time.

Another option (provided that the system is connected to a neuro-navigational equipment after registration of the fixed position of the patient's head) is to designate any point in the volumetric data set made of e.g. the head of the patient earlier after the (image) reconstruction of that volumetric data set, and to position the holder of the console accordingly. The matching, i.e. registration, of the absolute coordinate system of the console and of the 3D volumetric data set of the patient—and hence the recognition of the spatial position of the patients head—is done by setting the pointer located on the holder of the console (the length of the virtual pointer is adjustable; the pointer is either the auto focus of camera 9 or a laser printer fitted to the holder) to the markers fixed on the patient's head previously. The various trajectories can be specified after the input of the coordinates of the centre(s)/line/plane of rotation and the spatial positions defining the trajectory.

After having defined every points of the trajectory with the spatial position planning module, the camera(s) 9 is (are) moved along the trajectory by the console and a camera control module—this is what we call scanning. Camera 9 emits a signal to the console and camera control module upon reaching each point of the trajectory, and the module makes a picture in every position.

Console and Camera Control Module

The console and camera control module allows to give a coordinated command series to the electronics of the console and to camera 9, to bring the holder of the console into a predetermined position along the trajectory calculated by the spatial position calculation module and to activate camera 9.

The console and camera control module may be in permanent contact with the neuro-navigational unit (see below), and may receive permanent input data on the position of the patient in the form of spatial coordinates. This makes it possible to set the console on the basis of the volumetric data set. This is necessary in order to be able to plan the region prior to starting the operation (and after registration and the fixing of the head) to be scanned during operation and then subjected to image reconstruction. Since the console emits position coordinate data, registered by the neuro-navigational unit with the spatial coordinates of the patient, on a continuous basis, it is possible for the neuro-navigational unit to show the position of the holder of the console relative to the head of the patient, and to reconstruct any section of the volumetric data set. This function will be needed in order to produce a print screen version at each distinctive point of the trajectory of the sections of the volumetric data set shown actually in the given position on the display unit by tapping the monitor output.

This function can be realized more elegantly if the module itself is capable of reading the volumetric data set. In this case, after registration, a two-way system can be established via the neuro-navigational unit between the real-world image content and the volumetric data set, allowing that, while browsing in the volumetric data set, the corresponding graphic (image) information be displayed as well, but this may also happen the other way round, that is, while browsing in the graphic information, the image reconstructed at those spatial coordinates in the main planes will appear simultaneously. Hence the images reconstructed from the MR, CT or other volumetric data sets can also be displayed interactively by the spatial image reconstruction module. That is, one may assign to each image the appropriate sections of the image reconstructed from a volumetric data set (MR, CT).

The console and camera control module is constantly informed of the position, i.e. spatial coordinates, of cameras 9. Hence, if no neuro-navigational unit is needed, then image acquisition and processing will take place without that. Once the holder reaches a certain position in space—along the trajectory planned by the spatial position planning module—, the console and camera control module also activates camera 9, so that a stereo image pair is made in each position, but the stereo effect can also be produced by using one camera 9 and generating the stereo effect from the adjacent images. After having downloaded the images, spatial position coordinates are assigned to each image, according to the trajectory.

The console and camera control module can control the speed of the console, the virtual rotation axis length and the focal length, either analogously or digitally.

The parameters of individual trajectories, together with registration produced by the neuro-navigational unit as well as the layers generated by scanning are arranged into approaches, which in turn are grouped into projects, in the database. In this way, they can be retrieved, set, occasionally modified, deleted or reproduced at will.

Camera 9 is moved along the trajectory by the console and camera control module. It is essential for that purpose to have a hardware system moving the holder in a stable and vibration-free manner, so that occasional jolts during movement should not cause shifts in the images, which would then affect the movement of the final reconstruction montage and cause confusion (which, however, could be corrected by the software later on).

Spatial Image Reconstruction Module

The spatial image reconstruction procedure is an image browsing program based on a conception allowing to place each image of the 3D or 4D image stock in the space reconstructed virtually by computer, on the basis of their respective spatial positions.

In the course of browsing, the images can be retrieved and displayed in any order. The essence of the procedure is that each image in this space should be assigned position coordinates (in the manner described above) defined relative to the origin either of the console's own coordinate system, or of the coordinate system of the volumetric data set, after registration of the console's coordinate system with the volumetric data set. After display, the reconstructed image stock and its parts can be manipulated as desired.

A possible embodiment of the image reconstruction method consists of the following steps/features:

Each image produced in the course of image acquisition is provided with spatial coordinates describing its position relative to points of the pre-defined trajectory.

Images are downloaded in sequential order, and the points of the trajectory are also ordered, e.g. in a log file, on the basis of which the images are later re-named, so that their respective file names specify their coordinates required for image identification/reconstruction and for the retrieval of the images.

Reconstruction means that the images are reconstructed according to their respective coordinates and arranged virtually, in space. This can be done by the previously mentioned spatial position planning module, too. The spatial position planning module defines the trajectory by points anyway. Individual image layers, on the other hand, can be specified by adjusting the focal length setting in the case of a volumetric data set or in the image control unit itself, e.g. with the help of the mouse scroll button (that is, in this case, Z coordinates would be monitored, with a given deviation) or in some other way.

The image is shown by pointing at any place on the surface of an already drawn image grid (generated on the basis of parameters X, Y and Z of the trajectory), in which case the image made there will appear. For this purpose, it is sufficient to have a prism-shaped point set as image controller, with the images arranged by their X, Y and Z coordinates only, since no further 3D movement can be perceived on a computer monitor anyway. If, on the other hand, PAL optics are used for the purpose image acquisition, the image controller unit shall provide a movement allowing at any time to load images by two more coordinates or directions, namely tilting and perpendicular tilting, while rotation (over viewing) will not be accessible. Rotation will be the single movement that will only be accessible through the digital rotation of the images. The new solution will allow not exclusively jumping to adjacent images (as was the case in the procedure used so far), but to load an image from any point of the image grid and start viewing or image browsing from there. If the mouse is drawn, so to say, along adjacent points, image display will be similar to what happens in the known procedure. Shifts between the image layers, on the other hand, are performed with an accessory function or by pushing a button, as described in detail above, but the latter will depend also on the display unit and the image viewing hardware, e.g. image viewing glasses, attached to it.

The current procedure can be transformed so as to retain movement in the image and add movement in the image grid. In the case of the image grid, reconstruction can be based on the spatial coordinates, but also on the number of the horizontal and vertical lines, respectively. The images are placed in the image grid—according to their sequence order —, then an image grid corresponding to the number of positions is created, and an image is assigned to each grid point. Pointing or drawing the mouse to a point in the image grid will result in the actual image being shown.

As the relevant plane sections of the volumetric data set are also available, these, too, can be assigned spatial position coordinates in the manner outlined already, the same as the images, and browsing in the volumetric space will also load the MR or CT image associated with the given image. Hence the actual surgical or dissection image will appear beside the volumetric data (images). It is more advantageous, however, if the volumetric data set—the DICOM file—is read and interpreted and, preserving the registration of the neuro-navigational system, browsing in the image controller will load not only the actual images, but also the volumetric image reconstructed in the same spatial position. If the approach was made with the help of the neuro-navigational system (for it is the neuro-navigational system that can reconstruct again from the volumetric data set the actual aspects/planes on the basis of the spatial coordinates of camera 9 of the console), pointing to the volumetric data set will load at any time the image reconstructed in that position, even in an aspect perpendicular to the axis direction of camera 9.

This makes it possible to show images created on the basis of any pattern, not only one scanning pattern, the usual option to date.

Image processing is followed by their automatic spatial positioning, and the montage can be viewed and occasionally deleted or manipulated immediately.

Image layers are arranged in approaches, and approaches, in turn, into projects. Their parameters can be retrieved at will, scanning can be repeated at any time, the unnecessary image layers can be deleted or replaced.

Approaches are arranged as follows. Browsing in the image reconstruction montages is also feasible by selecting a certain region on the virtual head shown in the display, and selecting animation, live operation or anatomic dissection within that.

The synchronization of the image window (if several image reconstruction montages are studied simultaneously, for example for the purpose of comparison) is much easier in the case of several approaches, as images are loaded on the basis of their spatial coordinates. It is always possible to identify the same depth, calculated from the centre of rotation, among the image reconstruction montages.

Contour-drawing required for naming the image parts can be done as follows. Contours assigned to the same image/image part can be assigned not only colors, but also the position coordinates of the image, in which case they can be loaded from a single file, and there is no need for using a mask file specifying the contours of each image, the solution applied in MIGRT. It is sufficient to have a single supplementary file containing information on the contours in the folder comprising the image stock of a layer.

It will be understood from the above that we have solved the problems described in detail in the introductory part of the present invention. The arched section is portable, small (around 50 cm×50 cm×1 cm, i.e. 20×20×0.4°), mountable on the operative table, light (around 10-15 kp). Portability allows fast transfer from one operating theatre to another as well as rapid mounting, but the apparatus can also be mounted on other consoles or the ceiling for that matter. Its manufacture is not cost-intensive. It is designed, primarily, for the purpose of image acquisition, but it facilitates stereotactic approaches, too. The console for the purpose of image acquisition and image reconstruction introduced by the present invention overcomes many of the procedural and structural limits of the prior art system. Henceforth, the positioning of the holders of the console will be fully automatic, but as precise as it used to be. Continuous scanning in this form will reduce the time demand of image acquisition (to around 0.5 to 1 min.) to such extent as will make the entire technology accessible in the surgical room, without implying a significant increase in the duration and hence risks of operations. The parameters of the console will make this technology widely accessible for the purpose of image acquisition, image reconstruction and stereotactic planning and targeting, replacing in these areas the by-and-large obsolete, robust robotic microscope, not manufactured any more. Image acquisition will be faster, and also fully automatic. Since the neuro-navigational unit allows to return to the same spatial grid position at any time (the only criterion will be the extent of the registration error), it will be possible to execute simulation operations on laboratory cadavers precisely and nicely, without the need to fit 35-40 hours of work into a single session. Furthermore, it will be possible to use it in surgical operations, too, as described in detail above, due to the significant reduction in image acquisition time and the fact that navigation promotes pre-surgical planning, in the present case for the purpose of image acquisition, with the help of the console according to the present invention.

The fact that the system is fully automatic helps overcome the main barrier: trajectory size and image number will no longer be a problem; the field of vision can be extended, the number of images increased to enhance the quality and quantity of the final image reconstruction montage and make it smooth and without jolts.

The errors due to the manual control of the system, detailed above, will also be eliminated: it will no longer be possible to ‘forget’ to trigger the camera, as the entire process will be automatic, and in case a picture is omitted for some reason, it will be possible to reproduce the same position and repeat even that single exposure. These factors, too, will boost the quality of the image reconstruction technology. Since the parameters can be reproduced at any time, it is possible to repeat/delete entire scanning processes in a short time. Thanks to the holding-structure-based technology, there will be no need to limit the number of layers either, meaning, in the final analysis, that it will be possible to record even more surgical or other process stages. Fast image acquisition will allow easy correction of misalignments between layers through repetition or enhanced registration precision.

The use of the stereotactic console according to the present invention for surgical, so-called biopsy, sample collection also implies many novelties compared to the currently accessible stereotactic frame. The latter frame, without neuro-navigational unit, makes it indispensable to fix the frame to the head (invasively). Biopsy sampling currently includes several phases. First, the patient's scalp is anaesthetized under sterile conditions, in accordance with the rules of surgical approaches, then the frame is fixed to the in a short operation (drilling the screws into the skull). The frame itself is designed so as to allow to aim at the target in the head according to the X, Y, Z co-ordinates. After this minor operation, the patient is scanned in the CT or MR equipment, then returned to the operating theatre to be operated on after the manual setting (according to calculations based on CT or MR images) of the targeting device using the millimeter scale of the frame. All these stages can be avoided by using the stereotactic console, in which case the 3D data set of CT and MR images is interpreted by computer, and after the fixing of the head (e.g. by non-invasive mask) and registration required for neuro-navigation, navigation can be carried out and the holder of the console be set to the target after target selection on the computer. The process itself is similar to the known system, but instead of a robotic microscope, the holder of a console is moved in position, which may hold a stereotactic targeting device or even a camera. Instead of being fixed to the patient's head, the stereotactic device is secured, for example, to the operative table, which makes invasive screw drilling and frame-fixing by operation unnecessary.

The spatial image reconstruction technology is based on a novel conception. In contrast with prior art methods, individual images are not assigned names, but co-ordinates specifying their spatial position, i.e., the position of the camera at the time of their acquisition, indicated in the file name or elsewhere. Hence whatever the manner of image acquisition, each image of the resulting image set is assigned spatial co-ordinates on the basis of the chosen labelling convention (e.g., the first three digits of the file name may indicate the X and the next three ones the Y coordinate). Hence image reconstruction does not simply proceed in the order of image acquisition, the scanning pattern, i.e. order or pattern of image acquisition, of which can be interpreted by the known equipment/software programs, too, but data used for planning the trajectory are used for the reconstruction of the images of this virtual trajectory; and hence each trajectory position is linked to the matching image. The image is loaded or shown by an image viewer, a display unit or monitor, by moving the mouse in the image controller, e.g. a 3D prism containing the X, Y, Z coordinates of the trajectory. The advantage of this method is the much greater degree of freedom of navigation or maneuvering, extending access from jumps to/viewing of adjacent images to the loading/display of images matching any point of the spatial grid pointed at by the user. If the mouse is drawn through adjacent points, adjacent images will be shown, as in the known method. Another possible advantage of image marking by coordinates is that it is possible to assign to the real-world image acquired in a spatial position the matching reconstructed volumetric (CT, MR etc.) image, and hence both imaging modalities can be viewed at once.

Novelty of the spatial image reconstruction technology relative to the known solutions:

The known solution closest to the present invention is an upgraded version of two existing commercially available software products, linking the images of image layers, i.e. multi-layers, in the order of their acquisition, a procedure limited to showing adjacent images upon a mouse gesture in the image window, the same as in the case of the other known software products.

The spatial image reconstruction method offers a much greater degree of freedom of maneuvering by arranging the recorded images in accordance with their respective spatial position coordinates, or on the basis of the sequence of their acquisition, in a virtual space or virtual image grid or along the trajectory after having determined the grid size. Navigation may take place in the known manner, but the entire process is located in an image controller, the latter being, essentially, a reconstruction of every point of the trajectory or of the image grid. Moving the mouse on the surface of the image controller will load the image corresponding to the position of the mouse pointer ever.

The method is innovatory in making further functions available, e.g.:
Image window manipulation
Rotation
Magnification/reduction
Image window synchronization
Image material movement controller
Image marking and drawing unit
Adding of new projects to existing modules
Compression into file
Image renaming
Mirroring etc.

A ‘boring’ feature can also be incorporated by choosing a drill from the toolbar in the display and then starting to drill the images provided with coordinates. Thanks to the option of rotation at any depth, i.e. in any of the layers, it is possible to return to the drilling from another perspective.

The last sequences of image viewing can be preserved and the number of the stored sequences is set as desired.

If the images are recorded with PAL optics, the software must unpack the mapped picture. Another advantage of this solution is that a full, undistorted, panorama picture is taken at each moment of the continuous scanning, and hence, after reconstruction, it is possible to ‘look around’ at every moment in time, to see the panorama. There is one type of movement that is not allowed by this solution, namely the alteration of the over viewing orientation, but that can be solved by a software application, for example.

The neuro-navigational unit may be incorporated in the equipment or coordinated with the console as a separate unit, suitable for the processing and display of the volumetric (CT, MR etc.) data stock of a patient if the context is medical utilization. The registration of the actual head position of the patient and the volumetric data set stored in the neuro-navigational unit can be done in two ways. Either by an infra-camera representing part of the neuro-navigational unit, by pointing to the markers placed on the patient's head, identifying and registering the corresponding points of the volumetric data set stored in the neuro-navigational unit, then the discrepancy of the registration, i.e., the error between the actual head position of the patient and the volumetric data set is calculated by the software. Given the fact that the infra camera of the neuro-navigational unit sees the marker on the holder of the console, and after the registration of the actual head position of the patient, the neuro-navigational unit is in permanent contact with the console, the spatial position of the camera can be determined at any time relative to the spatial position of the patient's head and, accordingly, the neuro-navigational unit reconstructs the volumetric data set in the course of the movement of the camera, so that these images, too, are provided permanent co-ordinates, that can be reconstructed together with the real-world images, but this takes us back to the known procedure referred to in the introduction, too.

Or, the markers can be designated by the adjustable focal length of the console, the same as in the case of the known system, requiring no infra camera. Since the co-ordinates of the console are known and hence the markers can be placed in the system of coordinates of the console, this has to be registered exclusively against the volumetric data set stored in the neuro-navigational unit. The neuro-navigational unit allows to set the camera in the same position in case of another registration and hence it is possible to avoid any misalignment between images originating from inexact settings. Minor shifts can be corrected by the software application.

Several solutions are available for displaying a 4D image reconstruction montage. Firstly, the image receiving system of the console can be attached directly to glasses incorporating a small monitor, which makes it possible to use the equipment for the recording of events taking place directly, replacing thereby the currently widespread optical systems. The montage, however, can be viewed not only through these glasses, but also with any monitor or with equipment showing stereoscopic images.

Movement of the image reconstruction montage is conceivable both within the program or through an external hardware element (e.g. joystick), capable of simulating the degrees of freedom of the console, and capable of showing this 4D material on the same PC. Display can be realized with an image controller or an equipment detecting any movement of the position of the head. (This latter is an already developed, accessible, technology, with appropriate hardware elements.) Hence upon any movement of the head, the image material would automatically move in the appropriate direction. According to another solution, to be implemented with the help of another well-known technology, the position of the camera mounted on the console will change proportionally with the movement rotation of the head. The essential feature of this rotation is that, in addition to the image stock being rotatable, by altering the position of the head, the alteration of the image material produces an even more realistic effect than actually turning around the focal point. The focus can be adjusted at will, and so can the sensitivity of image rotation provoked by the movement of the viewer's head.

The image reconstruction montage, together with the browsing, spatial image reconstruction software can be written on CD as a finished product.

1-12. (canceled)

13. A mobile console for holding an image acquisition of medical device, primarily for brain surgical approaches,
comprising a holder fixing said device immovably and
first supporting arm including the holder,
the supporting arm comprising a single- or multi-member structure;
connected to a table in a rotating and hinged manner;
the first supporting arm being associated with at least one moving means moving it relative to the table;
the first supporting arm and/or moving means are associated with position/trajectory sensors;
said moving means and the position/trajectory sensors being connected to a control unit;
wherein
the first supporting arm including an arched section;
the holder being movably mounted in the arched section;
the radius of arched section exceeding the radius of a phantom circle extending around a target object, and the centre of rotation of the radius falls in the region of the centre of a circle;
the arched section being tiltably connected to a second supporting arm section guided in a vertically movable manner, said second supporting arm section being connected to an assembly consisting of a third supporting arm section guided in a way allowing movement parallel to a longitudinal direction of the table and a fourth supporting arm section guided so as to allow movement perpendicular to the longitudinal direction of table.

14. The mobile console according to claim 13, wherein the arched section includes a T-shaped guide, and the holder has a complementary-shaped groove.

15. The mobile console according to claim 13, wherein the arched section includes a T-shaped groove, and the holder has complementary-shaped extension.

16. The mobile console according to claim 13, wherein the holder is embedded in arched section through rotatably mounted wheels ensuring a no-clearance connection.

17. The mobile console according to claim 13, wherein the moving means comprise step motors.

18. The mobile console according to claim 13, wherein the holder includes a second moving means.

19. The mobile console according to claim 13, wherein the end of a flexible, but longitudinally rigid ribbon is attached to holder, while the other end of the ribbon is coiled on the axis of the moving means arranged at the end of arched section, and the ribbon is guided in a groove.

20. The mobile console according to claim 13, wherein the moving means of holder can be rotated around a rotation axis crossing the centre point of arched section.

21. The mobile console according to claim 13, wherein the arched section has a rigid profiled cross-section.

22. The mobile console according to claim 13, wherein the arched section is removably fixed.

23. A mobile console for holding an image acquisition of medical device, primarily for brain surgical approaches,
comprising a holder fixing said device immovably and
a first supporting arm including the holder,
the first supporting arm comprising a single- or multi-member structure and
connected to a table in a rotating and hinged manner;
the first supporting arm being associated with at least one moving means moving it relative to the table;
the first supporting arm and/or moving means are associated with position/trajectory sensors;
said moving means and the position/trajectory sensors being connected to a control unit;
wherein
the first supporting arm including an L-shaped section;
the holder being movably mounted on the L-shaped section;
the L-shaped section being tiltably connected to a second supporting arm section guided in a vertically movable manner, said second supporting arm section being connected to an assembly consisting of a third supporting arm section guided in a way allowing movement parallel to a longitudinal direction of the table and a fourth supporting arm section guided so as to allow movement perpendicular to the longitudinal direction of table.

24. A method for the 3D scanning of, in particular, approached parts of the human body, and the electronic recording and reconstruction of information regarding the scanned object surface, comprising the steps of
recording an image of the object surface in pre-defined area-units and along a predefined trajectory;
storing the individual image records in a retrievable manner in a database, by also assigning to each image a sequence datum referring to the sequence of recording;
displaying individual image recordings in the course of reconstruction of images after a retrieval based on the sequence data;
acquiring images in the course of the approach of the object surface, on one continuous object surface layer after the other, consecutively;
wherein individual images are stored not only with matching sequence data, but also with their respective position and/or recording time parameters specified relative to a predetermined reference point, so that the reconstructed images are displayed on the basis of retrieval information based on any of either the sequence data, the position parameters or the recording time parameters.
